(19) United States
(12) Patent Application Publication
(10) Pub. No.: US 2022/0156665 A1
(43) Pub. Date: May 19, 2022

(54) SYSTEMS AND METHODS FOR ORCHESTRATING AGENTS

(71) Applicant: Above Daas, Inc., Phoenix, AZ (US)

(72) Inventors: Dirk Karsten Beth, Phoenix, AZ (US); Austin Jess Burch, San Francisco, CA (US)

(21) Appl. No.: 17/534,745

(22) Filed: Nov. 24, 2021

Related U.S. Application Data
(63) Continuation-in-part of application No. 16/258,040, filed on Jan. 25, 2019, now Pat. No. 11,209,816.
(60) Provisional application No. 62/622,523, filed on Jan. 26, 2018.

(51) Int. Cl. G06Q 10/06; G05D 1/02; B60W 60/00

(52) U.S. Cl. CPC G06Q 10/06316; G05D 1/0276; B60W 2556/45; G05D 1/0291; B60W 60/001

(57) ABSTRACT

A system for orchestrating a plurality of agents including an electronic device and a server. The electronic device is structured to: display a graphical user interface that generates maneuver configuration data for configuring a shared maneuver for the plurality of agents; and to transmit the maneuver configuration data. The server has: a maneuver interface circuit structured to interpret the maneuver configuration data, a maneuver configuration circuit structured to configure the shared maneuver; an agent data interface circuit structured to interpret first agent data and second agent data, the first agent data corresponding to a first agent of the plurality of agents and the second agent data corresponding to a second agent of the plurality of agents; and an agent coordination circuit structured to generate a plurality of coordinated agent command values configured to operate the first and the second agents based at least in part on the configured shared maneuver.

### CROSS-REFERENCE TO RELATED APPLICATIONS

This application is a continuation-in-part of U.S. patent application Ser. No. 16/258,040, filed on Jan. 25, 2019, and titled “AUTONOMOUS LONG RANGE AERIAL VEHICLES AND FLEET MANAGEMENT SYSTEM” (ABOV-0002-U01).

U.S. patent application Ser. No. 16/258,040 (ABOV-0002-U01) claims the benefit of U.S. Provisional Pat. App. No. 62/622,523, filed Jan. 26, 2018, and titled “AUTONOMOUS LONG RANGE AIRSHIP” (ABOV-0002-P01).

Each of the foregoing applications is incorporated herein by reference in its entirety for all purposes.

### BACKGROUND

Conventionally operating autonomous, unmanned or mixed fleets of vehicles has been challenging for a variety of reasons. For example, vehicles of disparate types often cannot communicate with one another adequately. This typically arises from proprietary protocols utilized by various vehicle vendors and often makes performing even relatively routine missions difficult.

What is needed is an orchestration platform or hub that facilitates communications between vehicles of various types.

### SUMMARY

The description herein references port facility applications as a non-limiting example and for clarity of the present description. However, embodiments described herein are applicable to other applications having similar challenges and/or implementations. Without limitation to any other application, embodiments herein are applicable to any application involving coordination of autonomous and/or manned vehicles. Example and non-limiting embodiments include one or more of: industrial equipment; robotic systems (including at least mobile robots, autonomous vehicle systems, and/or industrial robots); mobile applications (that may be considered “vehicles” and/or “agents”, as those terms are described herein), smart cities, and/or manufacturing systems. It will be understood that certain features, aspects, and/or benefits of the present disclosure are applicable to any one or more of these applications, not applicable to others of these applications, and the applicability of certain features, aspects, and/or benefits of the present disclosure may vary depending upon the operating conditions, constraints, cost parameters (e.g., operating cost, integration cost, data communication and/or storage costs, service costs, and/or downtime costs, etc.) of the particular application. Accordingly, wherever the present disclosure references an agent, a vehicle, a vehicle system, a mobile application, industrial equipment, robotic system, and/or manufacturing systems, each one of these are also contemplated herein, and may be applicable in certain embodiments, or not applicable in certain other embodiments, as will be understood to one of skill in the art having the benefit of the present disclosure.

Embodiments of the current disclosure are related to orchestrating manned and unmanned vehicle missions and facilitating integration with third-party or external systems such as customer relationship management (CRM), enterprise resource planning (ERP), logistics, field service, or similar software services. Embodiments of the current disclosure provide for a system and/or platform that may be used to integrate different vehicle types such that they may be used together in a mission. Further, certain embodiments of the system provide an interface for accessing mapping, routing and scheduling data, including for use indoors, at private or campus locations, and/or other areas/locations that typically are not mapped.

Embodiments of the current disclosure may be used in, and/or otherwise applicable to, a variety of contexts. For example, an inspection mission may be performed by pairing two different types of autonomous vehicles to cooperate to achieve a mission. The mission may be built using a platform via a workflow designer tool. As used herein, the terms “workflow” and “maneuver” refer to the collection of tasks and/or processes forming part of a mission, i.e., an objective, e.g., inspecting one or more towers on a power line, loading a vessel with cargo and/or unloading the cargo from the vessel, etc. Non-limiting examples of a task include: navigating to a waypoint; taking an image of an object; picking up an object; dropping off an object; etc. The workflow designer tool may permit a user to plan a mission via selecting vehicles and mission parts or tasks. The platform may provide listings of vehicles that are compatible with one another and the platform, along with listing the vehicles' capabilities, to facilitate mission planning In some embodiments, missions are for manned and/or unmanned vehicles in private locations, such as ports, where the mission includes performance of tasks such as container or asset location, pickup, and relocation, with reporting to a back-end system such as a logistics tracking and reporting software. As explained in greater detail herein, embodiments of the platform may provide for a user to enter in basic information about a workflow, wherein the platform is able to generate and/or otherwise determine the details for executing the workflow. For example, a user may specify a few details for a workflow such as Ship A needs to be unloaded by time X. The platform may have access to one or more agents, e.g., vehicles, that may be electrically powered, wherein the system automatically generates and coordinates a schedule for the agents to unload Ship A by time X with the agents performing electrical recharges.

Embodiments of the platform may also include features to permit simulated missions to facilitate mission planning and optimization tasks. For example, a digital twin of a given vehicle or asset may be provided such that it may be selected for inclusion in the mission irrespective of its current availability to an operator or user. As used herein, a “digital twin” is a computer model of a real-world asset or other item, e.g., a fuel truck, a dock crane, a shuttle craft, a human worker, etc., that mimics and/or tracks the behavior and/or properties of the real word asset. As will be appreciated, this allows the operator or user to test a vehicle's compatibility and capabilities in the context of a simulated mission prior to investing in the vehicle or including it in a particular mission.

Embodiments of the platform may provide for: a traffic and scheduling controller for multiple autonomous vehicles or vehicle providers operating in a shared space, e.g., ensuring that drone traffic is adequately prioritized, deconflicted, and scheduled for missions; incorporation of distributed ledger technologies, e.g., providing a decentralized marketplace for task bidding, point-to-point (PTP) operations, and peer-to-peer (P2P) transactions; and/or providing security protocols to ensure mission data is secure and resistant to attack or spoofing, e.g., by employing protocols similar to blockchain-based distributed trust among drones or other trusted sources.

Accordingly, embodiments of the current disclosure may provide for a system and method for orchestrating a plurality of agents. The system may include an electronic device and a server. The electronic device may be structured to display a graphical user interface that generates maneuver configuration data for configuring a shared maneuver for the plurality of agents. The electronic device may be further structured to transmit the maneuver configuration data. The server may be in electronic communication with the electronic device and have a maneuver interface circuit, a maneuver configuration circuit, an agent data collection circuit, an agent coordination circuit, and an agent command value provisioning circuit. The maneuver interface circuit may be structured to interpret the maneuver configuration data. The maneuver configuration circuit may be structured to configure the shared maneuver based at least in part on the maneuver configuration data. The agent data collection circuit may be structured to interpret first agent data and second agent data, the first agent data corresponding to a first agent of the plurality of agents and the second agent data corresponding to a second agent of the plurality of agents. The agent coordination circuit may be structured to generate a plurality of coordinated agent command values configured to operate the first and the second agents based at least in part on the configured shared maneuver, the first agent data, and the second agent data. The agent command value provisioning circuit may be structured to transmit the plurality of coordinated agent command values.

Other embodiments of the current disclosure may provide for an apparatus for orchestrating a plurality of agents. The apparatus may include a maneuver interface circuit, a maneuver configuration circuit, an agent data collection circuit, an agent coordination circuit, and an agent command value provisioning circuit. The maneuver interface circuit may be structured to interpret maneuver configuration data. The maneuver configuration circuit may be structured to configure a shared maneuver for the plurality of agents based at least in part on the maneuver configuration data. The agent data collection circuit may be structured to interpret first agent data and second agent data, the first agent data corresponding to a first agent of the plurality of agents and the second agent data corresponding to a second agent of the plurality of agents. The agent coordination circuit may be structured to generate a plurality of coordinated agent command values configured to operate the first and the second agents based at least in part on the configured shared maneuver, the first agent data, and the second agent data. The agent command value provisioning circuit may be structured to transmit the plurality of coordinated agent command values. Yet other embodiments of the current disclosure may provide for a method for orchestrating a plurality of agents. The method may include: interpreting maneuver configuration data; configuring a shared maneuver for the plurality of agents based at least in part on the maneuver configuration data; interpreting first agent data corresponding to a first agent of the plurality of agents; and interpreting second agent data corresponding to a second agent of the plurality of agents. The method may further include: generating a plurality of coordinated agent command values configured to operate the first and the second agents based at least in part on the configured shared maneuver, the first agent data, and the second agent data; and transmitting the plurality of coordinated agent command values.

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

### BRIEF DESCRIPTION OF THE FIGURES

FIG. 1 is a schematic diagram of a system for orchestrating a plurality of agents, in accordance with an embodiment of the current disclosure;

FIG. 2 is a schematic diagram of another embodiment of a system for orchestrating a plurality of agents, in accordance with an embodiment of the current disclosure;

FIG. 3 is a schematic diagram of another embodiment of a system for orchestrating a plurality of agents, in accordance with an embodiment of the current disclosure;

FIG. 4 is a flow chart depicting a method for orchestrating a plurality of agents, in accordance with an embodiment of the current disclosure;

FIG. 5 is a flow chart depicting another method for orchestrating a plurality of agents, in accordance with an embodiment of the current disclosure;

FIG. 6 is a flow chart depicting another method for orchestrating a plurality of agents, in accordance with an embodiment of the current disclosure;

FIG. 7 is a diagram of a graphical user interface for orchestrating a plurality of agents, in accordance with an embodiment of the current disclosure;

FIG. 8 is another diagram of a graphical user interface for orchestrating a plurality of agents, in accordance with an embodiment of the current disclosure;

FIG. 9 is another diagram of a graphical user interface for orchestrating a plurality of agents, in accordance with an embodiment of the current disclosure;

FIG. 10 is another diagram of a graphical user interface for orchestrating a plurality of agents, in accordance with an embodiment of the current disclosure;

FIG. 11 is another diagram of a graphical user interface for orchestrating a plurality of agents, in accordance with an embodiment of the current disclosure;

FIG. 12 is another diagram of a graphical user interface for orchestrating a plurality of agents, in accordance with an embodiment of the current disclosure;

FIG. 13 is another diagram of a graphical user interface for orchestrating a plurality of agents, in accordance with an embodiment of the current disclosure;

FIG. 14 is another diagram of a graphical user interface for orchestrating a plurality of agents, in accordance with an embodiment of the current disclosure;

FIG. 15 is another diagram of a graphical user interface for orchestrating a plurality of agents, in accordance with an embodiment of the current disclosure;

FIG. 16 is another diagram of a graphical user interface for orchestrating a plurality of agents, in accordance with an embodiment of the current disclosure;

FIG. 17 is another diagram of a graphical user interface for orchestrating a plurality of agents, in accordance with an embodiment of the current disclosure;

FIG. 18 is another diagram of a graphical user interface for orchestrating a plurality of agents, in accordance with an embodiment of the current disclosure;

FIG. 19 is another diagram of a graphical user interface for orchestrating a plurality of agents, in accordance with an embodiment of the current disclosure;

FIG. 20 is another diagram of a graphical user interface for orchestrating a plurality of agents, in accordance with an embodiment of the current disclosure;

FIG. 21 is another diagram of a graphical user interface for orchestrating a plurality of agents, in accordance with an embodiment of the current disclosure;

FIG. 22 is another diagram of a graphical user interface for orchestrating a plurality of agents, in accordance with an embodiment of the current disclosure;

FIG. 23 is a diagram of a mission view of a graphical user interface for orchestrating a plurality of agents, in accordance with an embodiment of the current disclosure;

FIG. 24 is another diagram of a graphical user interface for orchestrating a plurality of agents, in accordance with an embodiment of the current disclosure;

FIG. 25 is another diagram of a graphical user interface for orchestrating a plurality of agents, in accordance with an embodiment of the current disclosure;

FIG. 26 is a diagram of an apparatus for orchestrating a plurality of agents, in accordance with an embodiment of the current disclosure;

FIG. 27 is a flow chart depicting another method for orchestrating a plurality of agents, in accordance with an embodiment of the current disclosure;

FIG. 28 is a diagram of an agent, in accordance with an embodiment of the current disclosure;

FIG. 29 is a diagram of a workflow, in accordance with an embodiment of the current disclosure;

FIG. 30 is a diagram of an architecture for a system for orchestrating a plurality of agents, in accordance with an embodiment of the current disclosure; and

FIGS. 31A and 31B depict a diagram of another architecture for a system for orchestrating a plurality of agents, in accordance with an embodiment of the current disclosure.

### DETAILED DESCRIPTION

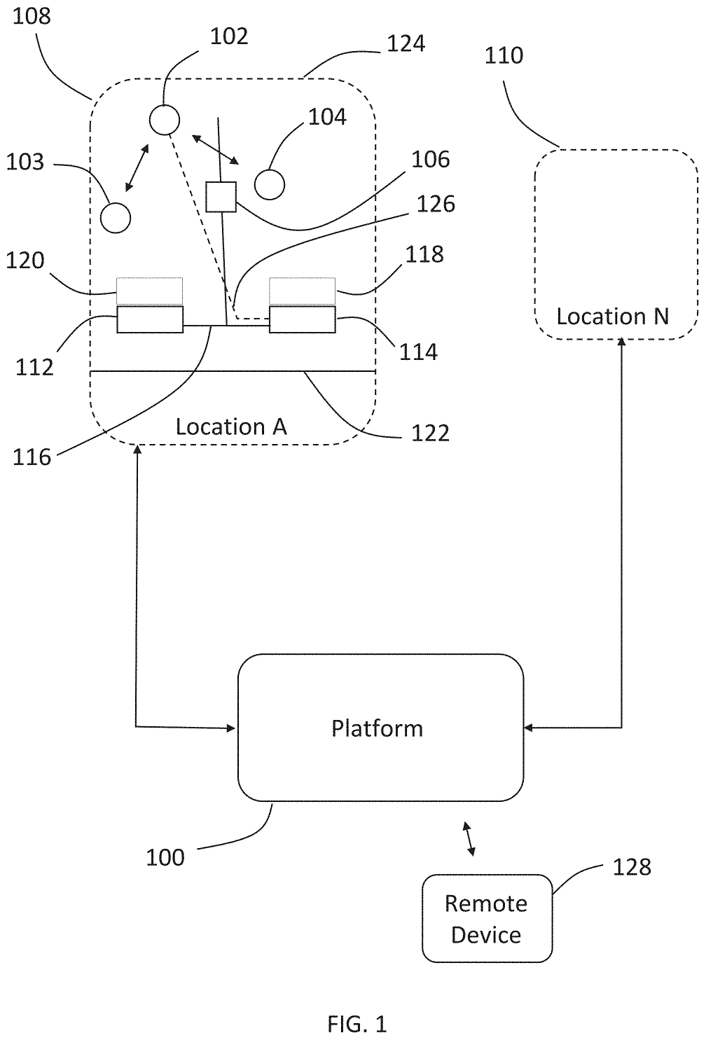

Referring now to FIG. 1, an example system/platform 100 may integrate various software modules for representing and controlling manned and unmanned vehicles and provide them to a user such that they are available for mission planning, building, simulation or execution. As shown in FIG. 1, the platform 100 may communicate with agents, e.g., vehicles, 102, 103, 104, 106 in a location (e.g., Location A 108, which may be a port (or other type of location described herein, and/or location N 110) as viewed from above as in the example of FIG. 1). The location 108 may include various assets 112, 114, such as shipping containers. Additional environmental information may be available to the platform 100, e.g., preferred or required routes, paths or roads 116, designated areas where vehicles are not permitted 118, 120, physical boundaries 122, e.g., between land and water, geofence location 124, etc. This environmental information may be provided to the platform from the owner or operator of the location 108, from a site visit to the location 108, from an external source (e.g., satellite imagery or mapping service data), produced synthetically, e.g., for a simulated location, or a combination of the foregoing.

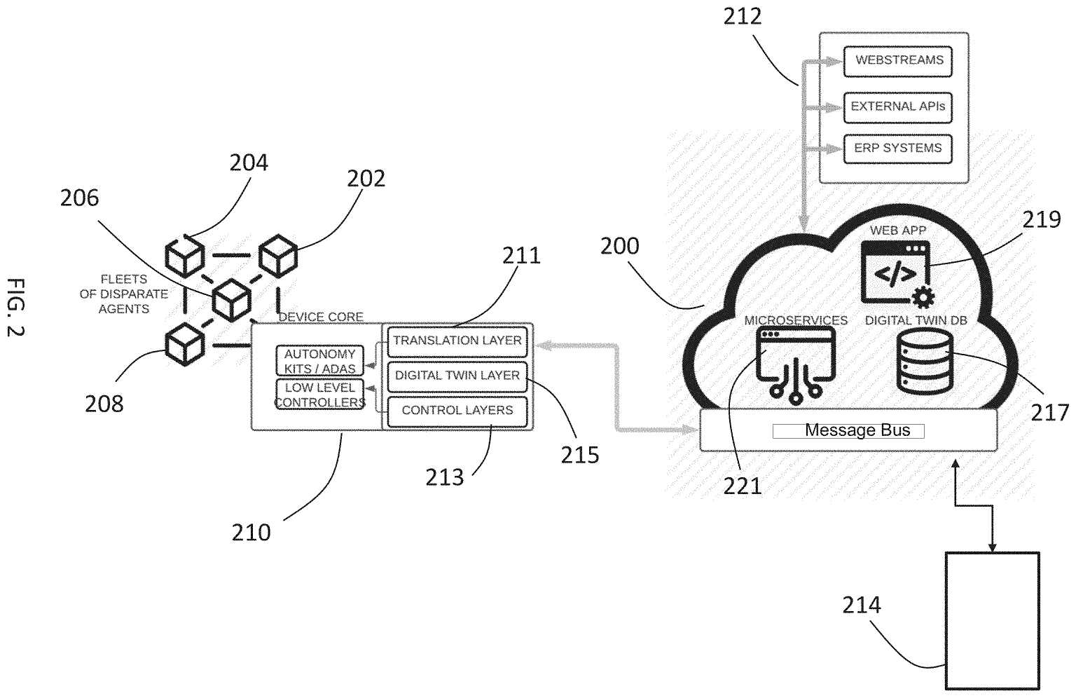

Turning to FIG. 2, the platform 200 may be implemented as a cloud platform that offers microservices that act in part as an integration layer or middleware layer that facilitates communications between devices of different types, e.g., devices 202, 204, 206 and 208, which may be from different vendors and utilize different communications protocols. Non-limiting examples of microservices include an application programming interface (API) to a system concerning data for businesses, weather, payment processing, etc., and/or a software agent that operates on a main server and/or on a vehicle. In embodiments, a microservice may be an agent. As such, in embodiments, the platform 200 may add communications capabilities for a set of devices, device types, or protocols, e.g., devices 202 and 208, such that platform 200 is capable of communicating with each of devices 202 and 208 independently, even if these devices cannot communicate directly. In some circumstances devices will be capable of communicating directly, e.g., devices 202, 204, and 206, and the platform 200 will incorporate this information into mission planning tools, as further described herein. In embodiments, the platform 200 may communicate with various device types independently, e.g., devices 202 and 208, to coordinate communication between the devices 202 and 208, for example mapping or converting communications from one or more devices 202 and 208 to a format consumable by the other of the devices. By way of example, the platform 200 may implement a message bus or queue from which devices 202 and 208 may obtain messages directed to the device 202 and 208, where the messages are formatted for consumption by the device in question.

As shown in FIG. 2, the devices may take the form of a fleet of disparate agents, e.g., devices 202, 204, and 206 may be of a first type, whereas device 208 may be a device of a second type, utilizing different communication protocols. In embodiments, a device core 210 (software) is provided to each device to facilitate communications, e.g., communicating and utilizing data of microservices offered by the platform 200. In embodiments, the device core 210 may include (a) a translation layer for consuming microservice data, or reporting data to the cloud via an IoT connection, as well as interfacing with the device's automation software or autonomous-driver assistance system (ADAS) software, (b) a digital twin layer that facilitates creation and management of the device's digital twin (as further described), as well as (c) a control layer for interfacing with the device's low level drivers that implement vehicle functions such as driving, breaking and directional movement.

By way of example, a combination of microservices offered in the cloud by the platform 200 and a device core 210 may provide for coordination of disparate fleets to operate within shared workflows. In embodiments, the platform 200 may have an IoT connection that provides for centralized orchestration and management (of the vehicles) via an IoT hub. A translation layer 211 in device core 210 may interpret the mission tasks indicated in a workflow from the platform 200 to determine a specific instruction set for any particular vehicle or group of vehicles. A tiered control layer 213 of device core 210 may provide for various types of control processes, such as coordinating requested workflow tasks with operation of the device's specific hardware capabilities. The device side digital twin layer 215 in device core 210 and cloud-side digital twin database 217 in platform 200 may provide for simulation and insights on digital assets. In embodiments, accompanying digital twin files, e.g., data files corresponding to one or more digital twins, may reside, e.g., be stored on, one or more file systems, e.g., an InterPlanetary file system (“ipfs”) private to a fleet. In embodiments, data relating to one or more digital twins may be segmented and/or linked to one or more coordinate systems, which may be in real-time data spaces and/or recorded in and/or verified via a blockchain. Non-limiting examples of coordinate systems include: absolute coordinates, e.g., Global Positioning System (GPS); relative coordinates, e.g., a coordinate system centered on a facility, a vehicle, and/or an arbitrary origin; etc. In embodiments, data relating to digital twins may be protected via a distributed network, e.g., a Byzantine Fault Tolerant distributed network.

In an example case of an inspection of a long linear transmission line, a user of the platform 200, e.g., via an interface provided in by a web application (web app) 219, may assign two vehicles 202 and 208, e.g., an automated guided vehicle (AGV) and drone, to work in unison to survey each transmission line tower and iteratively complete tower inspection workflows all the way down the transmission line. The two vehicles 202 and 208 may each have an IoT connection to the platform 200 such that they continuously transmit data relevant to the coordination and completion of the inspection mission. For instance, if the drone detects an anomaly, the drone may trigger further inspection, e.g., to conditionally collect additional or different data at a given tower location, and the AGV may in turn be tasked, e.g., by the platform 200, to wait on the drone and aid in transmitting a large dataset collected on the anomaly. As will be appreciated, data may be communicated to and from the cloud platform 200 via an appropriate communications link 212, such as reporting to or communicating with a backend device 128 (FIG. 1) or ERP system.

As may be appreciated, in embodiments, the infrastructure chosen may depend on the mission environment and agents or vehicles involved. In embodiments, a mission and/or operating environment may be configured by one or more blockchains and/or associated applications, and may be based at least in part on a workflow, as described herein. For example, in embodiments, a blockchain may configure one or more real-time data spaces in which agents of interest operate. In one non-limiting example, certain functions or services of the platform 100 (FIG. 1) may be distributed to one or more devices, e.g., devices 102, 103, 104, 106. For example, functions of the platform 100 such as facilitating vehicle-to-vehicle communication may be implemented by configuring devices such as devices 102, 103, 104 (FIG. 1) with the ability to store, process and send communications from one another or to act as a message coordinator or agent that performs processing, e.g., message translation, mission part assignments, etc., in proximity to the location as opposed to using a centralized device. As will be appreciated, this may reduce latency in communications between the devices, where one of the devices 102, 103, 104 acts as a local message processor for the mixed fleet of devices 102, 103, 104, 106. In some embodiments, the infrastructure chosen may depend on the mission function and required time, allowing different loop cycles to be intelligently implemented on varying devices as part of mission planning. By way of non-limiting example, a mission part performed by local vehicles may be best addressed by utilizing a vehicle-to-vehicle communication protocol, which may be associated with that mission part as part of mission planning automation, whereas backend reporting may allow for higher latency in data and use of a centralized or cloud connection or link to an external system 214, which also may be automatically assigned to communications related to completion reporting.

In another non-limiting example, a local network infrastructure may be configured to offer one or more of the services of the platform 200. For example, the services offered by platform 200 may be incorporated locally into a server of a local network to control data and reduce or prevent certain data from leaving a local network. In such an implementation, microservices 221 of a cloud may be included in local server environments. The device core 210 may then interact with a local microservice architecture to perform missions, support digital twin deployments for mission simulations, etc. The choice of architecture maximizes the orchestration functionality with intelligently deploying the most suitable architecture and communication protocols, and pipelining data to optimal compute locations whether in an edge device, a cloud device, at local servers, etc. This, in turn, may provide for new functionalities to be possible within a mixed system as well as in security sensitive or time dependent environments.

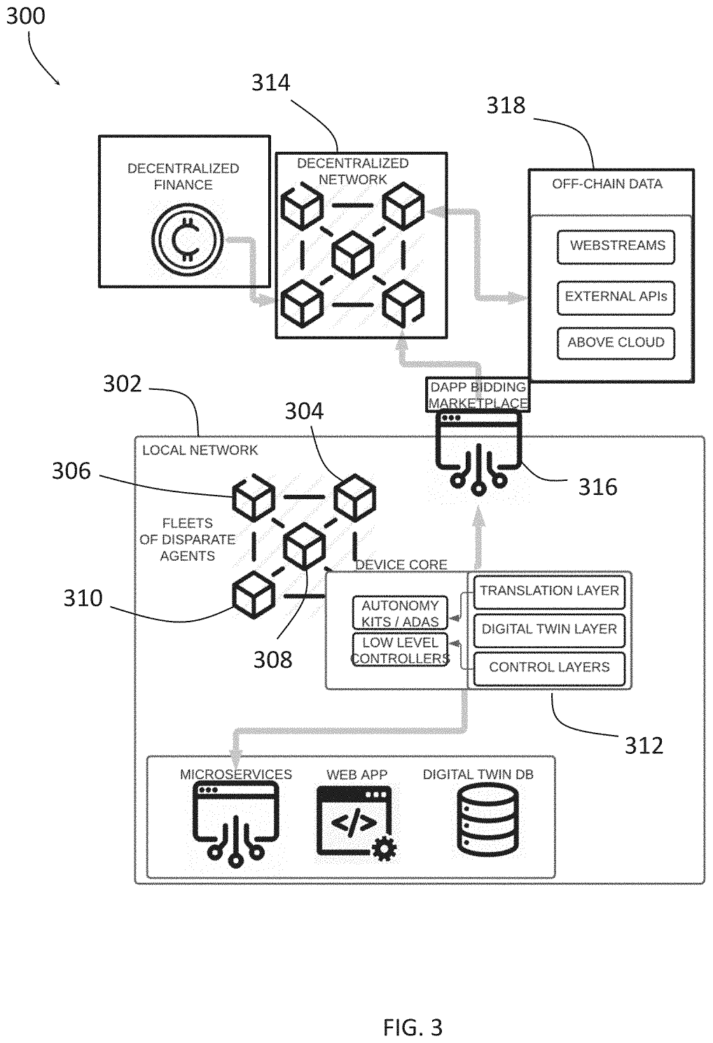

By way of a non-limiting example, in the case of a shipping port hub where most containers arrive and leave by the docks, most facility operations, e.g., the movement of freight, may reside within the shipping yard, making it more appropriate for a local network architecture. The port operator may have prioritized efficiency and security, and therefore want to limit cloud connections and dependencies. In a local network implementation, referring to FIG. 3, a device core 312 and digital twin deployment may be connected to microservices running on the local network to speed up and secure data communications. If local network traffic increases in such a deployment, i.e., a need for increased bandwidth is determined, one or more of messaging architectures and protocols may be adjusted to support higher throughput and deterministic protocols.

Similarly, certain functions or services of the platform may be provided on demand, e.g., when requested by a device 102, 103, 104, 106. In one example, a device 102 may receive a message from another device 103, where device 103 utilizes a protocol not recognizable or usable by device 102. In such a case, device 102 may communicate with platform 100 (FIG. 1), also shown as 200 (FIG. 2) and 300 (FIG. 3), which may be distributed among various devices 102, 103, 104, 106, to request a message translation service. Other scenarios are possible, e.g., requesting mission updates, vehicle assistance, etc.

In embodiments, services and/or microservices provided by the platform may be on a same architecture (“arch”) level as agents, e.g., vehicles and/or other assets as described herein. As stated above, a mission and/or operating environment may be configured by one or more blockchains, and/or associated applications, based on a workflow. As such, in embodiments, autonomous agents, physical and/or virtual, human agents, and/or real-time services may submit and/or participate in tasks and/or workflows. As such, some embodiments of the present disclosure may provide for a “level playing field” via a distributed approach which may allow and/or facilitate developers to monetize services, vehicle owners to provide simulation assets, and/or any agent to retain sovereignty over their corresponding data and/or tasks regardless of the stage or the workflow and/or task.

In embodiments, services and/or microservices may participate in publish and/or subscription actions, as described herein, which may be in a real-time environment. In such embodiments, the actions of a service and/or microservice may be recorded and/or verified via a blockchain, as also described herein. For example, transactions within a blockchain may record when a service and/or microservice subscribes to another service, is subscribed to and/or publishes data. In embodiments, services and/or microservices may have twin store values for optimization of inputs, training parameters, and/or other features described herein. In embodiments, one or more machine learning techniques, e.g., back propagation, may be used to tune the parameters of a service and/or microservice for scheduling efficiency with respect to the scheduling of agents. In embodiments, scheduling efficiency may include, but is not limited to: a shortest time to perform a particular action; monetary cost-efficiency, e.g., a least expensive way to perform a particular action; energy cost-efficiency, e.g., fuel and/or battery life; a prioritization based efficiency; etc.

As further described herein, the platform 100 may act as a traffic controller for various locations (e.g., Location A through Location N) or for devices, e.g., devices 102, 103, 104, 106, in shared locations. In some embodiments, the platform 100 provides scheduling and routing to devices in one or more locations to deconflict traffic, reduce congestion, prioritize certain traffic, missions or tasks, or otherwise facilitate coordinated and regulated movement for the devices. Similarly, in some examples, platform 100 may provide functionality that facilitates vehicle-to-vehicle communication and coordination by enforcing a deterministic communication protocol, e.g., enforces vehicle-to-vehicle communication for certain mission parts or agents, prioritizes communication timing or resources for mission parts or agents, etc. In embodiments, the platform 100 may deconflict agents, e.g., vehicles, based on one or more goals/intents of each agent being deconflicted. For example, a first vehicle delivering a time sensitive cargo, e.g., bananas, may be prioritized over a second vehicle transporting non-critical backup components to a warehouse. As another example, a first vehicle transporting cargo that is deemed to be late may be prioritized over a second vehicle transporting cargo that is deemed to be ahead of schedule. In embodiments, the platform 100 may base the prioritization of agents at least in part on one or more profiles, e.g., vehicles associated with a profile having characteristic A are, generally, to be prioritized over vehicles associated with a profile having characteristic B. For example, vehicles having a profile characteristic associated with the transportation of humans may be prioritized over vehicles having a profile characteristic associated with the transport of fuel.

In an embodiment, the data of the location 108 and its content (vehicles, assets, environmental information, etc.) may be made available for display by the platform 100 to an end user device, such as a mobile device of an operator of a vehicle, e.g., vehicle 102, at the location 108. In certain aspects, a routing for manned vehicle, e.g., vehicle 102, is provided by the platform 100. In other aspects, the platform 100 may be utilized to simulate a mission, for example providing one or more simulated vehicle(s) as digital twins for use in mission simulation. As further described herein, the platform 100 permits an end user to simulate missions or mission parts using digital twins of available vehicles or new vehicles not yet available to an end user.

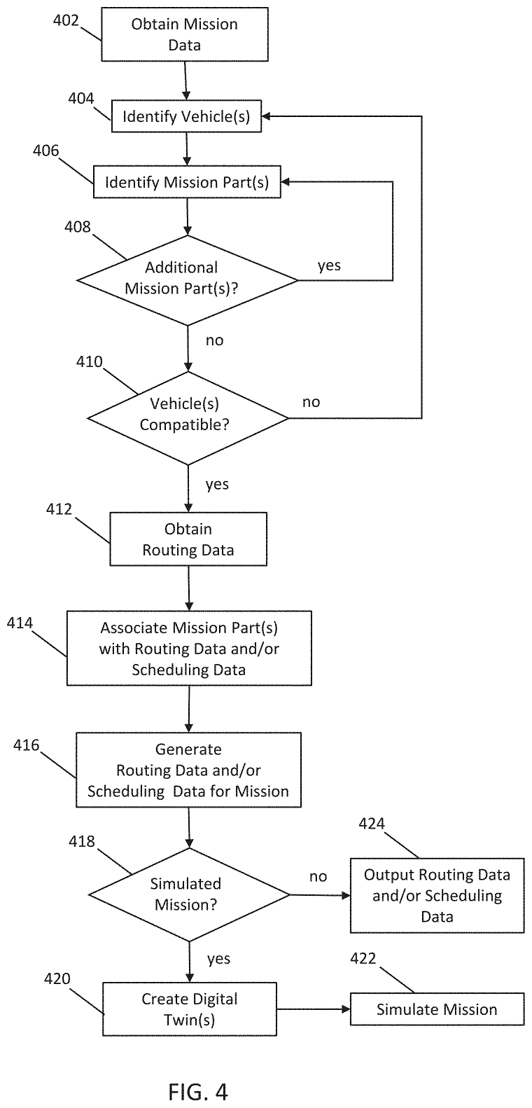

Referring to FIGS. 1 and 4, collectively, mission data may be obtained by the platform 100. As shown in FIG. 4, in the non-limiting example of routing for a manned vehicle, mission data may be obtained at 402 by the platform in a variety of ways; for example by scanning of a code, such as a QR code at vehicle 102 via a mobile device of the operator, which may initiate a network communication to the platform 100 that routing is required by the operator for the vehicle 102. In certain aspects, a mobile application running on the mobile device of the operator may be authenticated once during sign on or authenticated via the location of the mobile device, e.g., within a geofence such as 124, in proximity to vehicle 102, etc. As will be appreciated, this may avoid the need for an operator to authenticate or manually input data prior to obtaining routing instructions, i.e., trust is established due to the combination of the physical location of the mobile device in context (e.g., in combination with the QR code scan event, proximity to a vehicle available for a mission, etc.). In other aspects, mission data may be obtained at 402 in other ways. For example, mission data may be obtained automatically as a subtask within a mission protocol or workflow, may be created by an intelligent process, such as an automated process that detects a vehicle is incompatible or conditionally incompatible, such as low on fuel, and automatically suggests a substitute vehicle, as further described herein.

In embodiments, following the obtaining at 402, a vehicle is identified at 404, e.g., vehicle 102 is identified by the platform due to the coded information scanned and transmitted via the mobile application running on the operator's mobile phone. This may provide for the platform 100 to identify mission part(s) associated with the vehicle 102, as indicated at 406. For example, a predetermined mission may be planned for a manned vehicle, e.g., vehicle 102, on the basis of one or more factors present when the scanned code data is obtained by the platform 100. Non-limiting examples of the one or more factors include time, location, last mission, last mission status, mission imported from an external system, etc. By way of a non-limiting example, for a first mission of the day, manned vehicle 102 may be planned to perform a pickup and delivery of an asset, e.g., container 114, to another part of the location 100, per a business workflow or process from an external system, e.g., remote device 128. In such a scenario, the mission may be identified as having two parts at 406, i.e., a pickup part and a delivery part. If no more parts are needed, as determined at 408, the platform may optionally determine if the vehicles are compatible with one another and/or the mission, as indicated at 410. In embodiments, because a single unmanned vehicle, e.g., vehicle 102, is associated with the mission, this step may be omitted. In a non-limiting example of a multi-vehicle mission, a vehicle may be determined to be incompatible or conditionally incompatible, such as low on fuel. In such a circumstance, the platform 100 may automatically suggest a substitute vehicle as indicated at 404, respond to a vehicle's request for assistance, etc.

In the non-limiting example of providing routing for a manned vehicle, the platform 100 obtains routing data at 412. Here, the platform 100 may have access to data indicating a route 116 leading from vehicle 102 to container 114. This routing data may be associated with a mission part, e.g., the picking part of the mission, as indicated at 414. Further, because platform 100 may continually, periodically, or intermittently update its mapping information or state for the location 108, the platform 100 may have access to additional data that is useful in scheduling and/or routing. For example, in generating routing data and/or scheduling data, e.g., for vehicle 102, the platform 100 may be able to perform a check to determine that the route 116 is currently occupied by another vehicle, e.g., vehicle 106, according to the platform's current map state. Therefore, platform may choose a different or alternative route 126 for the vehicle 102 to complete its mission so as to avoid other vehicles, e.g., vehicle 106, and zones that are prohibited, e.g., 118, 120. The platform 100 may then generate the routing data at 416 for the mission.

In a non-limiting example where a simulation is being performed, e.g., an operator wishes to simulate vehicle 102 being tasked for picking container 114 at a given time, as determined at 418, digital twin(s) for one or more of vehicle 102, vehicle 106, and asset 114 may be generated for use in the simulation at 422. In many instances, a user of the platform 100 may wish to simulate a mission or part thereof prior to implementing it. For example, a simulation may be used to move the digital twins of vehicles 102, 106, and asset 114 about location A at a given time in order to ascertain the feasibility of the mission in terms of vehicle choice, routing, traffic deconfliction protocols, etc. As such, the platform 100 may be utilized as a convenient interface to trial certain missions or mission tasks, e.g., on the fly with minimal commitment. For example, a user may utilize the platform to form a mission that replaces one or more mission parts that are typically manned components or tasks with autonomous vehicles. The platform may then run a simulated mission, e.g., using previously captured data from a prior mission, with simulated autonomous vehicle involvement.

In embodiments, the routing data may be provided to the operator's mobile phone for display of routing guidance in the mobile application, as indicated at 424. In one non-limiting example, the platform 100 may provide or output at 424 displayable data or coordinate data that is combined with displayable data resident at the mobile phone application of the operator in the form of a map to provide turn-by-turn directions for guiding the operator of vehicle 102 to container 114 and any other part of the mission, e.g., to the delivery location.

In embodiments, the location of the mission may be a complex environment that requires multiple vehicles, manned and unmanned, to cooperate with one another. In a manned vehicle routing non-limiting example, a manned vehicle's routing instructions may be adjusted or modified based on real-time or near real-time data, such as obtained from other vehicles in the environment. As will be appreciated, this may provide for adjustment or modification to the mission protocol or part thereof, such as updated routing guidance based on human operator inputs (e.g., human operator deviating from a location of the route or timing thereof), based on unmanned vehicle locations or behaviors (e.g., movement to avoid one another or the manned vehicle, vehicle requests or offers assistance, etc.). As further described herein, adjustments or modifications to routing or other mission data may be accomplished using a variety of inputs from vehicles, human operators, or a combination thereof, which are provided as input to intelligent processes that are configured for dynamic mission updates, e.g., for handling complex traffic and congestion management tasks.

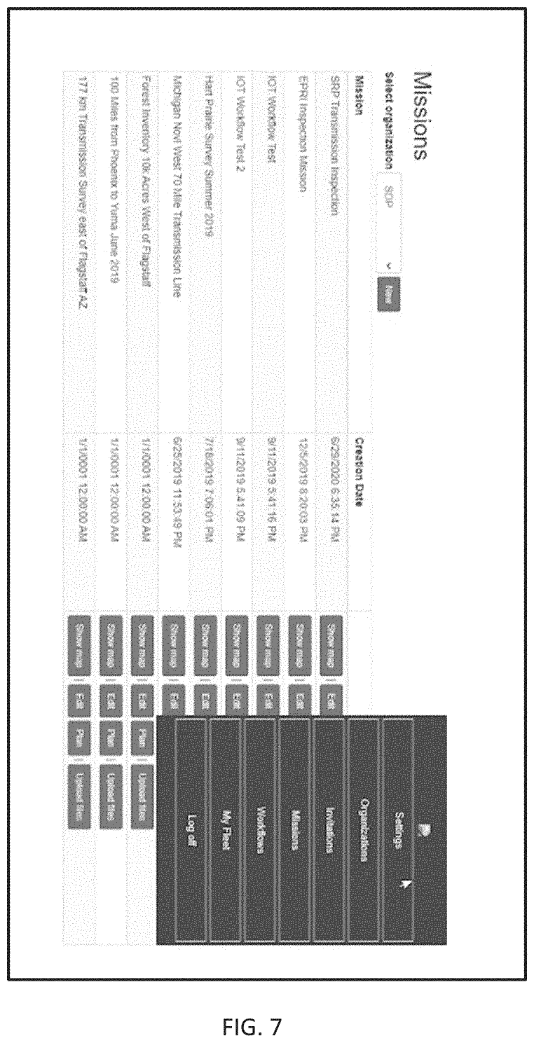

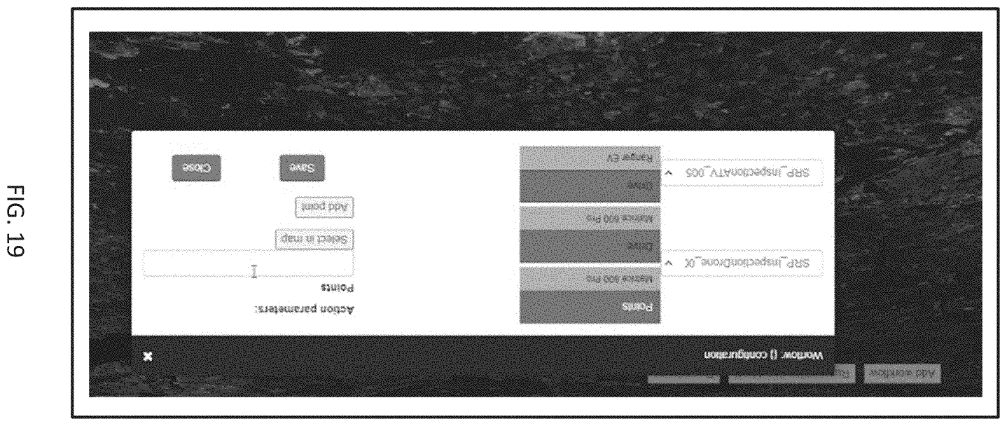

Referring to FIGS. 7-25, the platform 100 may provide a user interface, e.g., as a web application graphical user interface (GUI) provided in an internet browser, to permit a user to build a workflow or streamline together multiple tasks for multiple agents for a mission into a template (“workflow”, “maneuver” and/or “mission”). By way of non-limiting example, as shown in FIG. 7, the platform may provide a drop-down menu or other interface for selecting a mission type, i.e., providing for the platform 100 to obtain mission data at 402. For example, a user may select from predetermined missions (collections of tasks) or parts thereof (tasks) supported by the platform 100 given available locations, manned or unmanned vehicles, etc. By way of non-limiting example, the platform 100 may provide a template or dropdown menu allowing a user to select an inspection mission type, e.g., for a pipeline or powerline, that is preconfigured per a template including multiple tasks for the mission, which may be customized by the user. In other examples, the platform 100 may provide one or more application programming interfaces (APIs) that provide such data to an external system where the workflow is built, e.g., an ERP, logistics or other external system may surface a similar GUI for workflow building, which then passes data to the platform 100 for mission implementation and coordination of the vehicle(s). In embodiments, the platform 100 is a module that is incorporated into an external system.

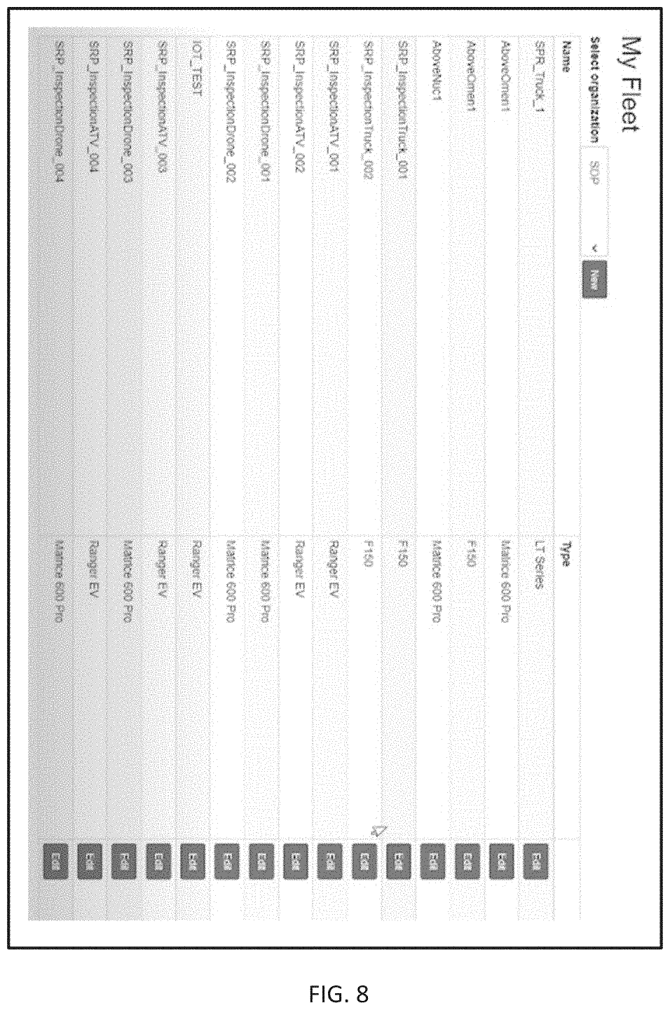

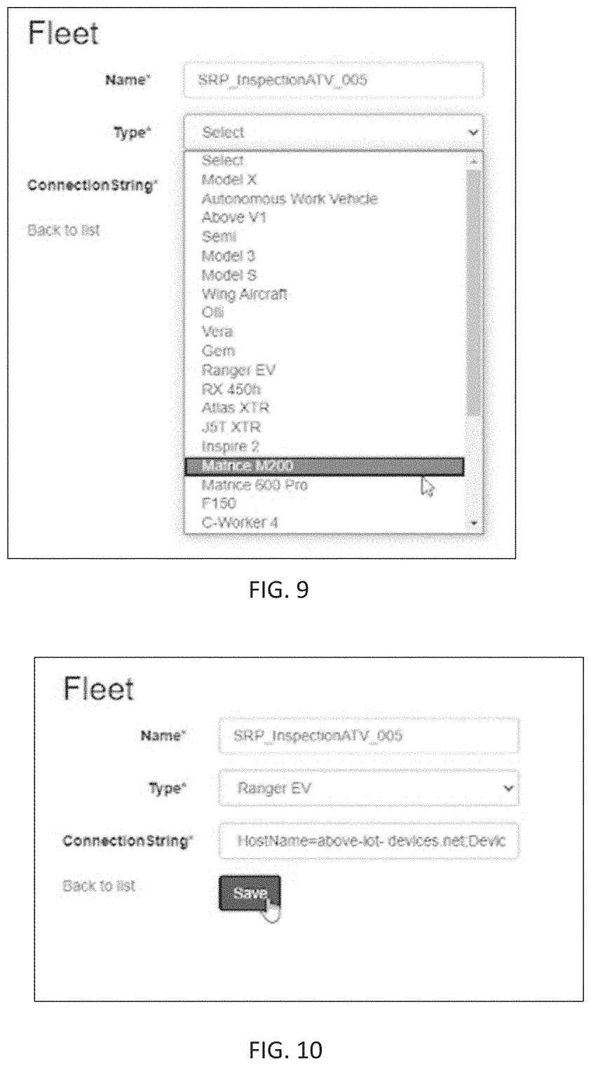

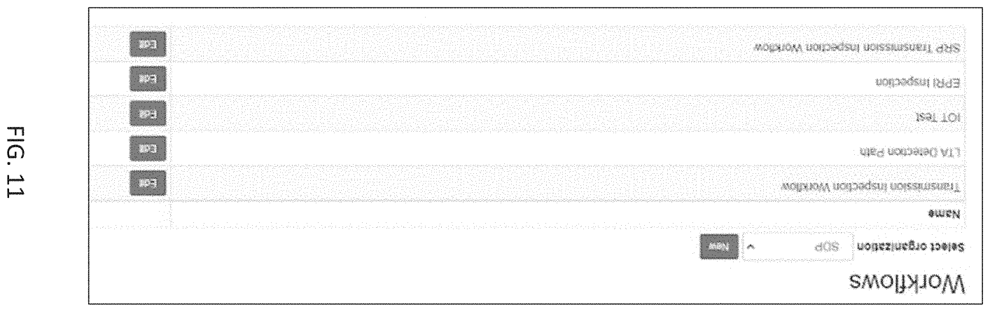

The missions may be predetermined or preloaded into the system, e.g., using templates, which may be customized by end users (e.g., selecting different vehicles, mission tasks, etc.). The missions may be created by end users, e.g., via a workflow designer tool, as for example illustrated in the series of FIGS. 8-17. By way of another non-limiting example, a user may select from a fleet of available vehicles, illustrated in FIG. 8, or add a new vehicle, as shown in FIGS. 9-10. Here, the platform may request user input to describe or name the vehicle, select its type, and provide a communication connection string to allow the platform to communicate with the vehicle. In yet another non-limiting example, the supported vehicle types are listed in a drop-down type menu, as shown in FIG. 9. A user may add the new vehicle to the fleet of available vehicles, as shown in FIG. 10.

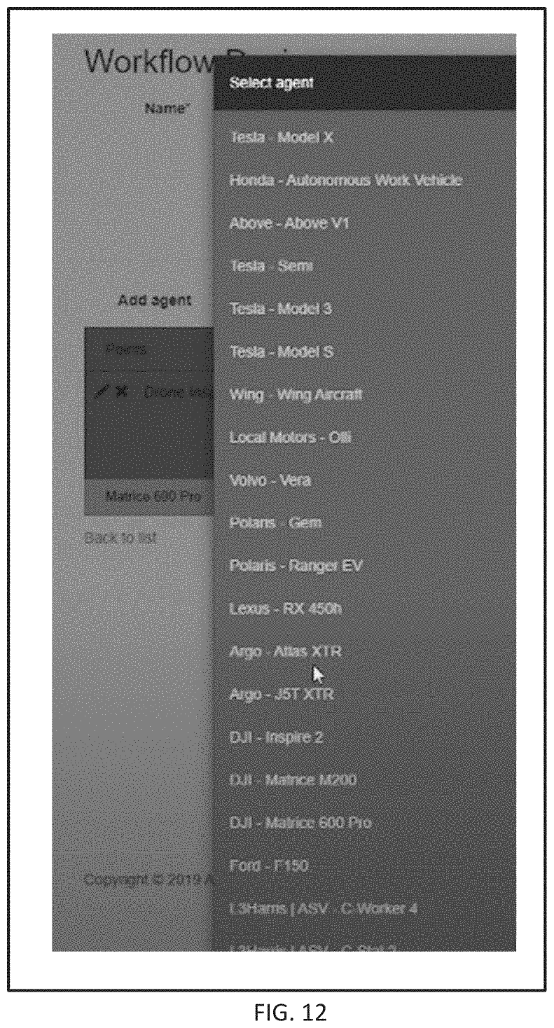

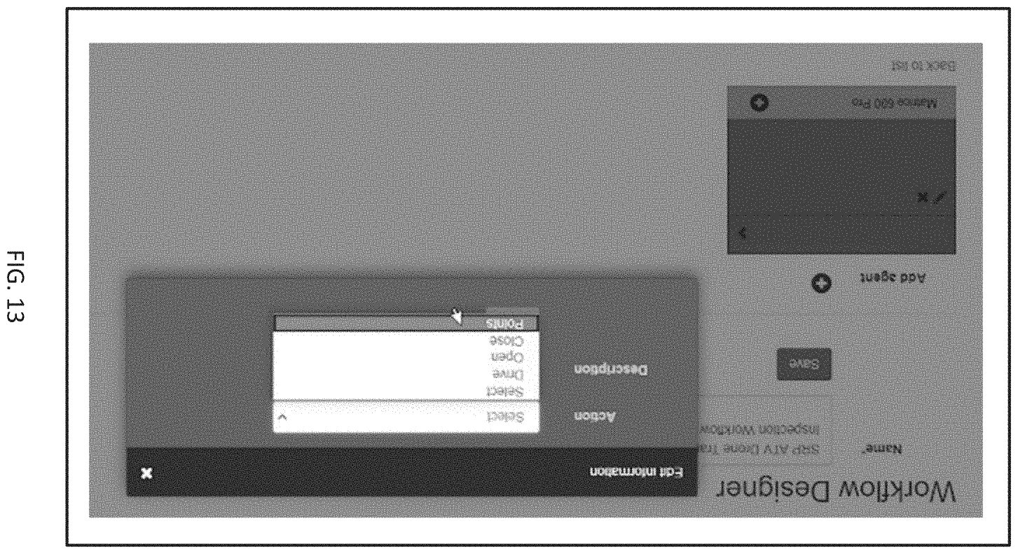

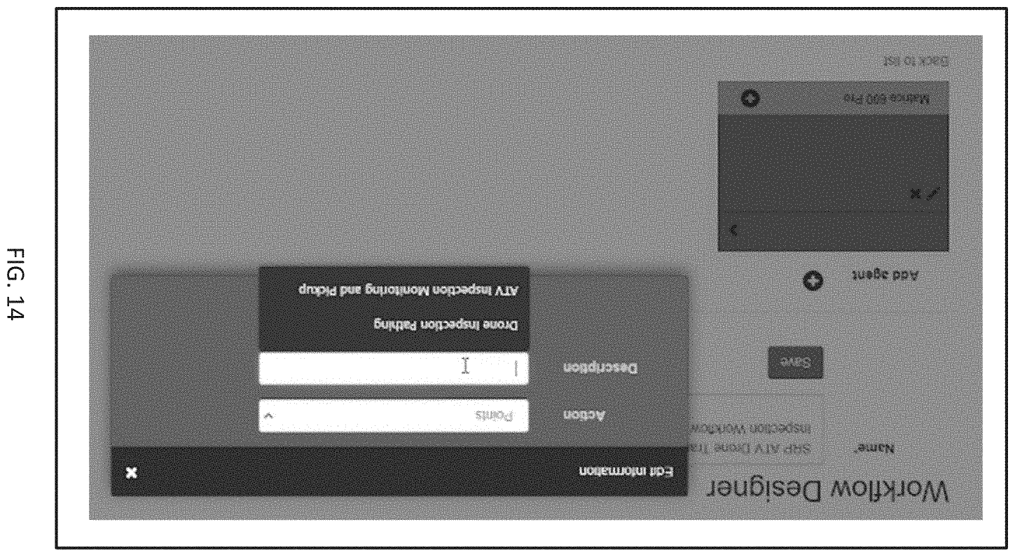

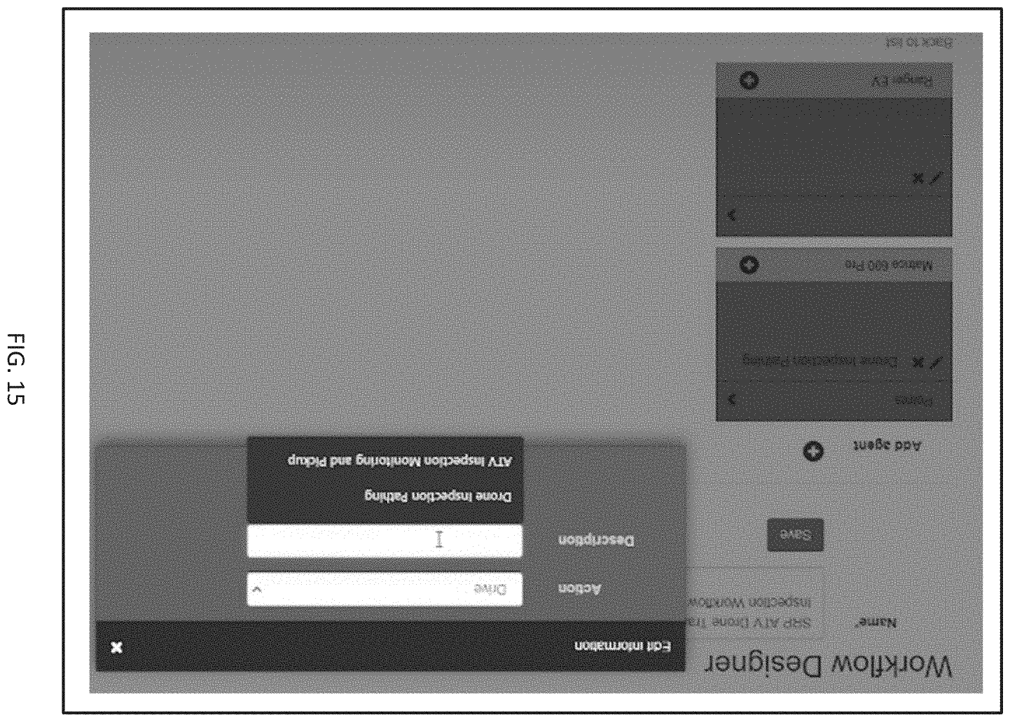

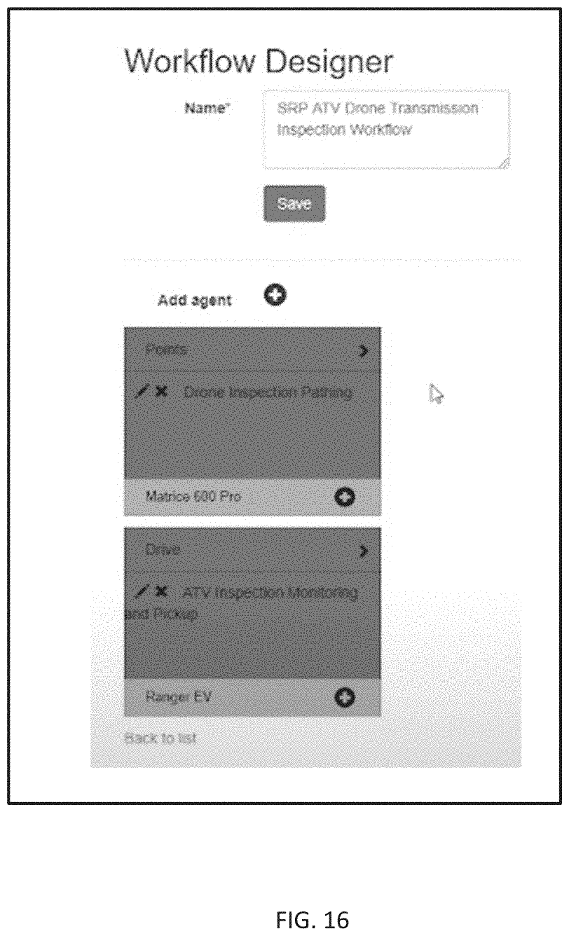

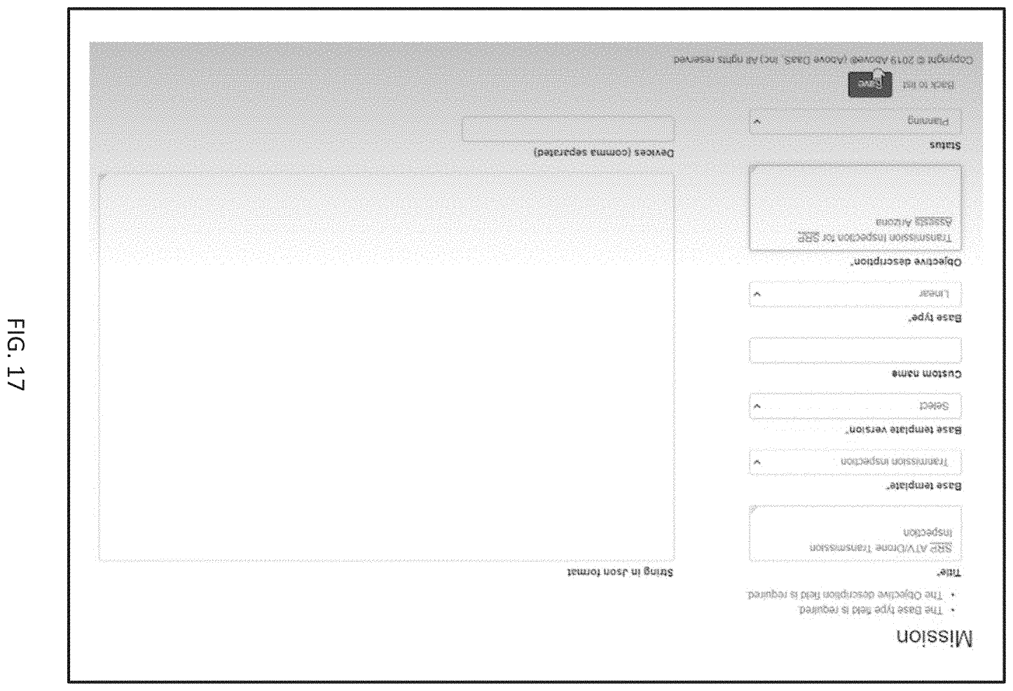

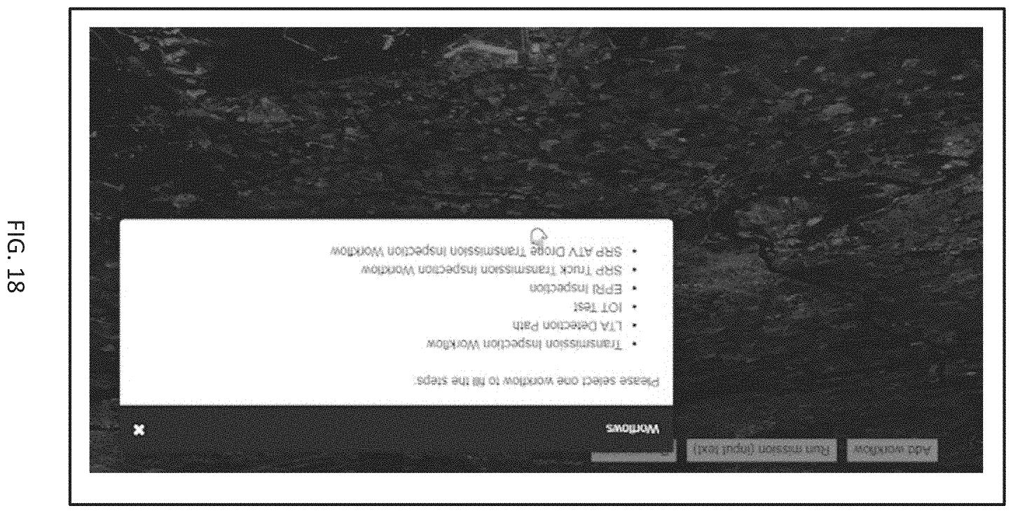

The available workflows likewise may be selected from, as shown in FIG. 11, or a user may build a new workflow using a workflow designer tool, as shown in FIGS. 12-16. In FIG. 12, a user may select a first agent or vehicle for inclusion in the workflow. Once an agent is selected, the user may indicate actions and descriptions for the agent, as shown in FIG. 13. For example, in an inspection mission, an action may be points, e.g., coordinate points, and a description may be drone inspection pathing, as illustrated in FIGS. 13-14. Similarly, if more than one agent or vehicle is to be included in the mission, the user may appropriately configure it as shown in FIG. 15, resulting in a workflow summary, displayed in FIG. 16. Once satisfied with the workflow summary, the user may add the workflow to a mission to form a template, as shown in FIG. 17. In embodiments this may add the newly created mission and underlying mission parts, defined by the workflow, to the list of available missions or mission templates, with one non-limiting example listing being shown in FIG. 7.

Given the user's selection of a mission type, the platform 100 may identify vehicle(s) that are available at the location for the mission type at 404, e g , manned vehicles, unmanned vehicles, or combinations thereof, based on the template for the workflow. At any point during mission planning or preparation, a GUI may be presented to the user with a drop-down menu listing the vehicles, their descriptions and capabilities, and basic tasks for which they may be used, such that the user may adjust the mission design. Thereafter, at 406, the platform may identify mission parts, e.g., in response to user inputs to a GUI indicating the workflow built previously that links parts of a mission together with associated vehicles. For example, a user may provide input to a GUI indicating a starting point or location for a mission, e.g., a particular tower on a power line selected from a map, etc. The user may thereafter indicate other waypoints or mission parts, e.g., additional towers along the power line that are to be inspected. In some examples, the drop-down menus may change dynamically, e.g., based on prior selections, for example elimination vehicle(s) or mission part(s) based on earlier selections, e.g., due to incompatibility, availability, range, cost, etc.

Having identified the vehicle(s) and mission part(s) at 404 and 406, the platform 100 may perform a vehicle compatibility check at 408. For example, a user may indicate a particular unmanned vehicle is to provide transport for a second type of unmanned vehicle, which is to perform visual inspection of the towers, e.g., using a camera to capture images of the towers, or use other sensor data to collect inspection information, such as a laser point cloud. The platform 100 may determine at 410 if the vehicles selected are compatible, e.g., capable of performing a mission task, working together to accomplish the inspection, communicate (directly or indirectly through the platform 100), etc. This may be implemented, for example, during the workflow design, at the end of workflow design, after a previous workflow template is updated, e.g., to indicate a new vehicle, during the mission, and/or at another suitable point in time.

In embodiments, a vehicle compatibility check, as indicated at 410, may take various forms, for example including an initial compatibility determination with respect to the vehicle selected as compared with the user input for a mission task, such as capability to perform a given task, availability to do so, or the ability to adequately communicate with other vehicle(s) that may be involved. One non-limiting example of such a compatibility check is a determination as to whether the vehicle is available, e.g., open in terms of scheduling, has sufficient power or payload capacity, adequate sensors, etc.

In embodiments, a compatibility check may involve determining if any additional or alternative task(s) are necessary or desirable. For example, the platform 100 or a vehicle may determine that in addition to the requested task, e.g., travel with another vehicle to a power line tower for inspection, another task or subtask is necessary, such as communicating routing or path information to other vehicles in the vicinity of a planned route. It is also noted, as with all other figures, the ordering or timing of a step may be modified. For example, a compatibility check may take place after a mission has begun, e.g., based on subsequent requests received by the vehicle, real-time sensed data such as proximity to other vehicles, fuel capacity, memory or data storage capabilities, requests or offers for vehicle assistance, etc. In an events-based manner, a mission or part thereof may be modified or adjusted, such as creating a modified task or new task or subtask, while the mission is being performed. Thus, examples include vehicle(s) requesting aid or assistance with a mission or part thereof while attempting to perform the part of the mission, accepting additional tasks or mission parts after a mission has been planned or commenced, etc.

In embodiments, if a vehicle is determined to be incompatible, the platform 100 may suggest a different type of vehicle, provide an indication or warning, and/or remove the vehicle or mission part from the mission. If the vehicles are compatible, the platform 100 may proceed to obtain routing data for performing the mission at 412.

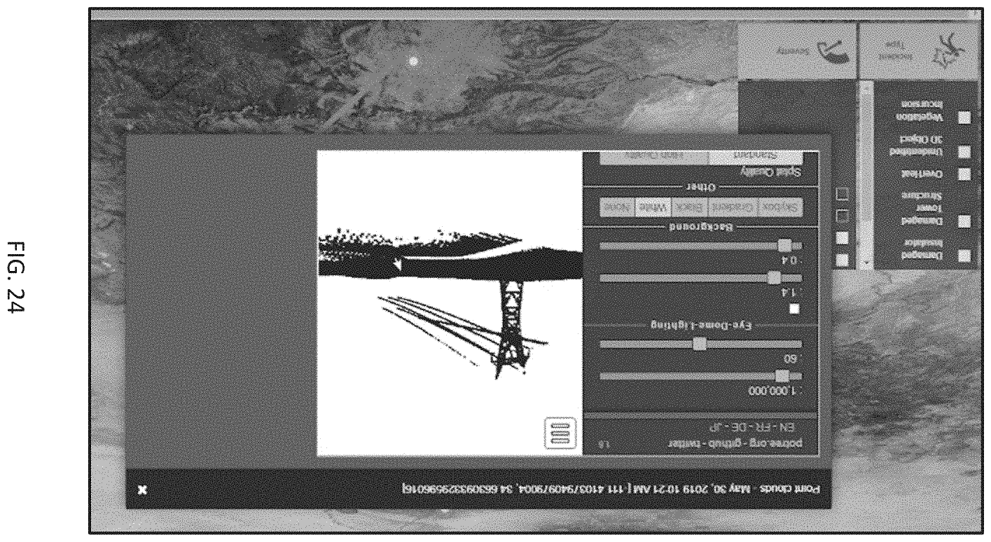

In embodiments, platform 100 may obtain coordinates for the towers to be inspected at 412 and format these into a sequence of instructions or waypoints for the unmanned vehicle(s), as indicated at 414 and 416. The platform 100 may communicate the routing data and other mission data to the unmanned vehicles as indicated at 424. In an example where a simulated mission is indicated, as determined at 418, digital twins for each selected vehicle may be generated at 420, i.e., having the characteristics of the selected vehicles, for use in a simulation which is performed at 422. A non-limiting example of a simulated mission view for a powerline tower inspection is provided in FIG. 23. In certain aspects, the platform 100 may output simulated mission data, e.g., instructing the digital twins to proceed to waypoints in a virtual simulation of the location, perform virtual inspections per the indicated workflow, collect simulated data, e.g., point clouds, images, etc., and return. This may provide for the platform 100 to operate as a simulator for mission planning, troubleshooting and optimization, prior to requiring the user to invest in vehicles, maps or models of the location(s), etc.

In embodiments, the platform 100 may instruct the vehicle(s) per the mission workflow as indicated at 424. For an example powerline tower inspection mission, the platform may present a GUI asking the user to select a workflow template for the mission, e.g., as designed via the workflow designer tool. In the example of FIG. 15, the user is provided with a variety of possible workflow templates for inspecting the powerline towers.

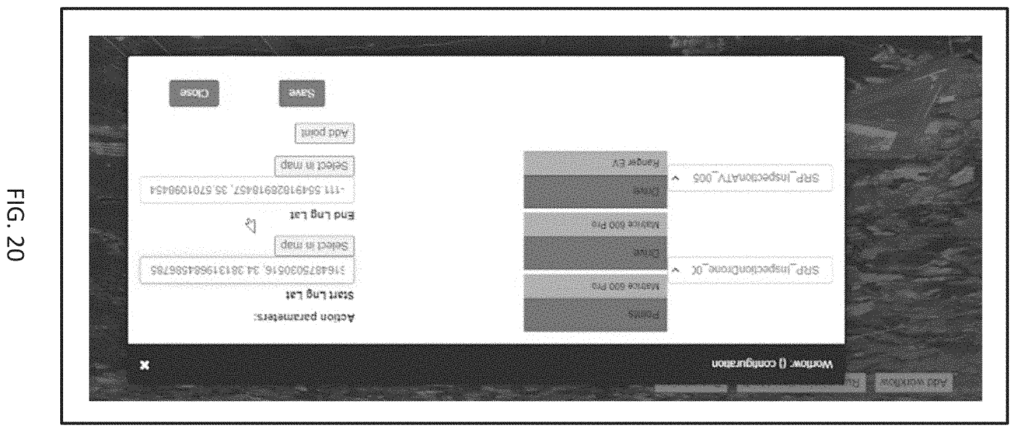

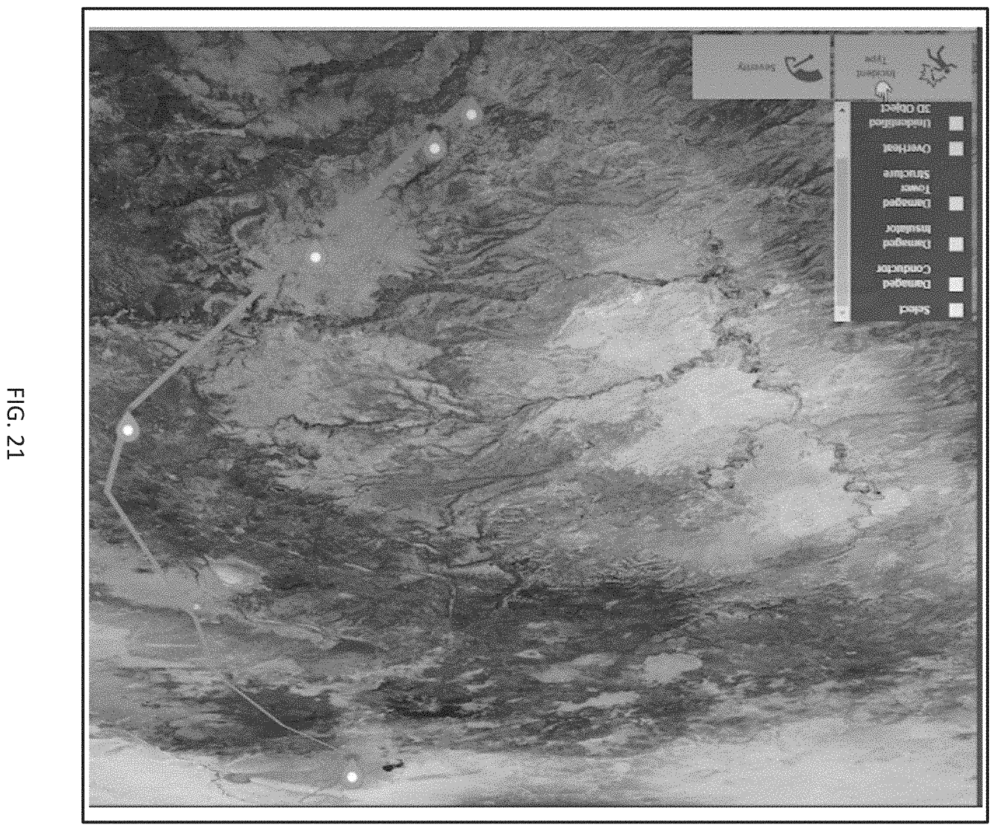

After a selection by the user, the platform 100 may present the user with information indicating the components or tasks of the workflow, as shown in FIG. 19. The user may again choose to adjust the workflow at this point prior to undertaking or simulating the mission. In the non-limiting example of FIG. 20, the user has adjusted the points at which the mission will begin and end via adding GPS coordinates to the appropriate parts of the mission. As will be appreciated, the user may also select location points in other ways, e.g., picking locations from a map view.

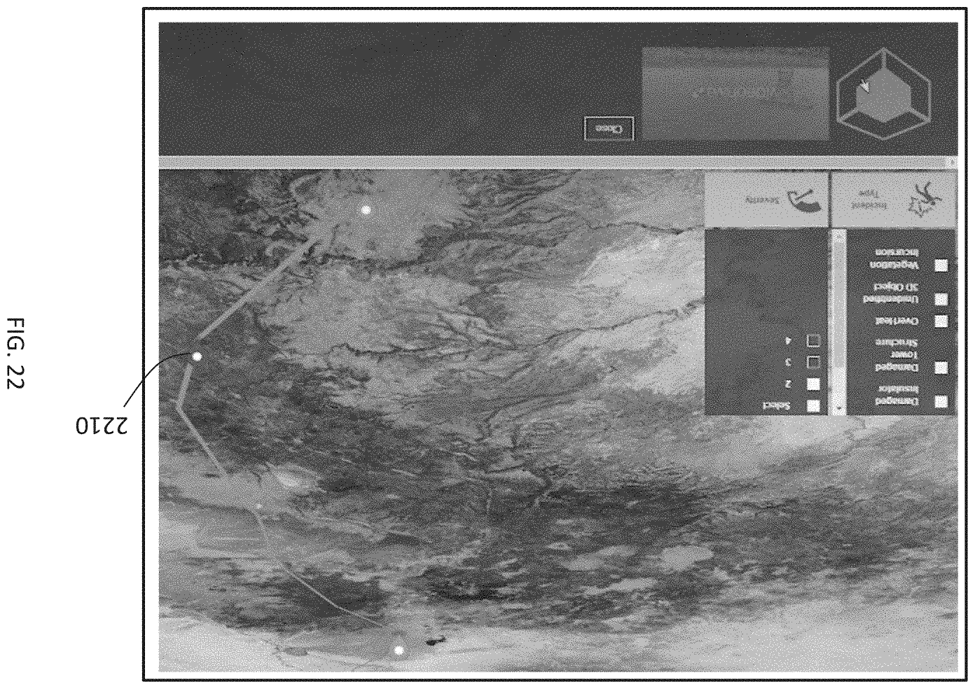

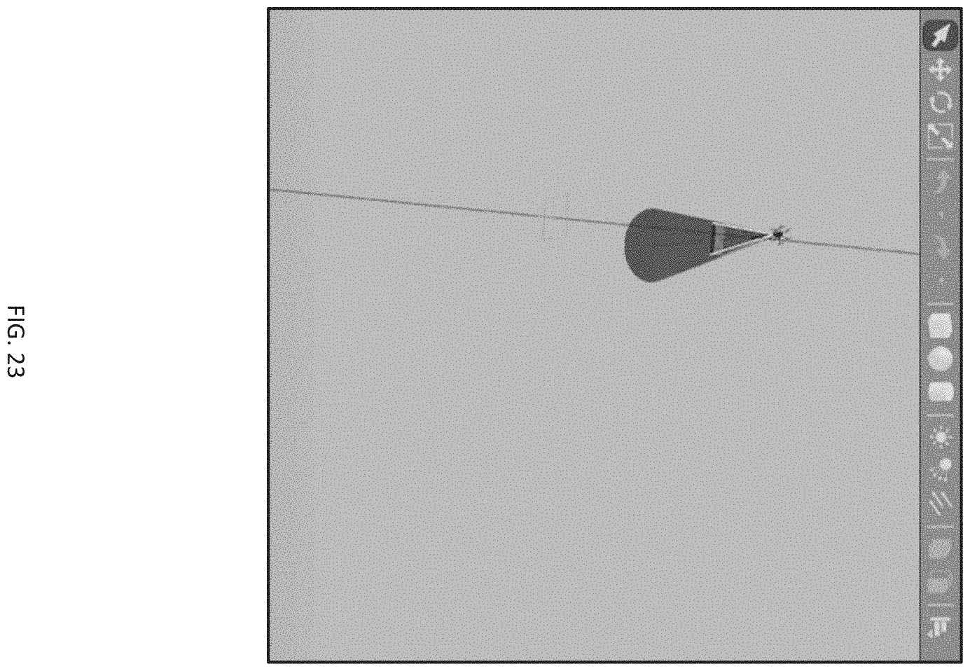

When the mission is run or simulated, the workflow may be used to provide the vehicle(s) instructions, e.g., waypoints as well as mission tasks associated with waypoints, e.g., capturing powerline tower imagery or point cloud data, etc. The user may review the mission plan in a map view with the waypoints highlighted. In the non-limiting example of FIG. 21, the mission has been run and the vehicles have reported data. As indicated in FIG. 21, the points at which important data, e.g., per the filtering criteria indicated in the left-hand faceted menu(s), may be highlighted for review. That is, the points on the map illustrated may correspond to powerline tower locations at which the vehicles have automatically collected data and anomalies are indicated per the faceted filtering criteria (e.g., features, severity ratings). FIG. 22 depicts a non-limiting example where the user has selected to view anomalies (or features, even if not anomalous) of damaged insulator, damaged tower structure, overheated, unidentified 3D object, and vegetation incursion of a particular severity rating, all of which can be identified for example via computer vision techniques that match these objects and data to reference objects and data.

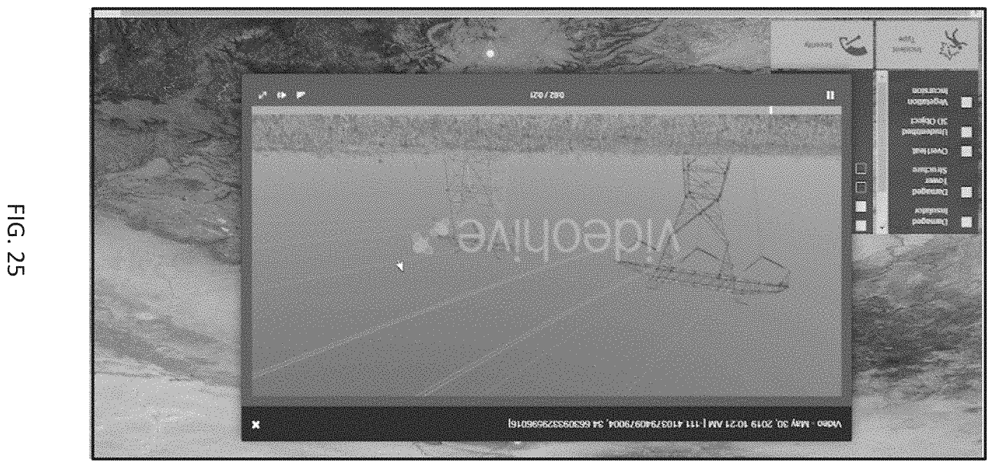

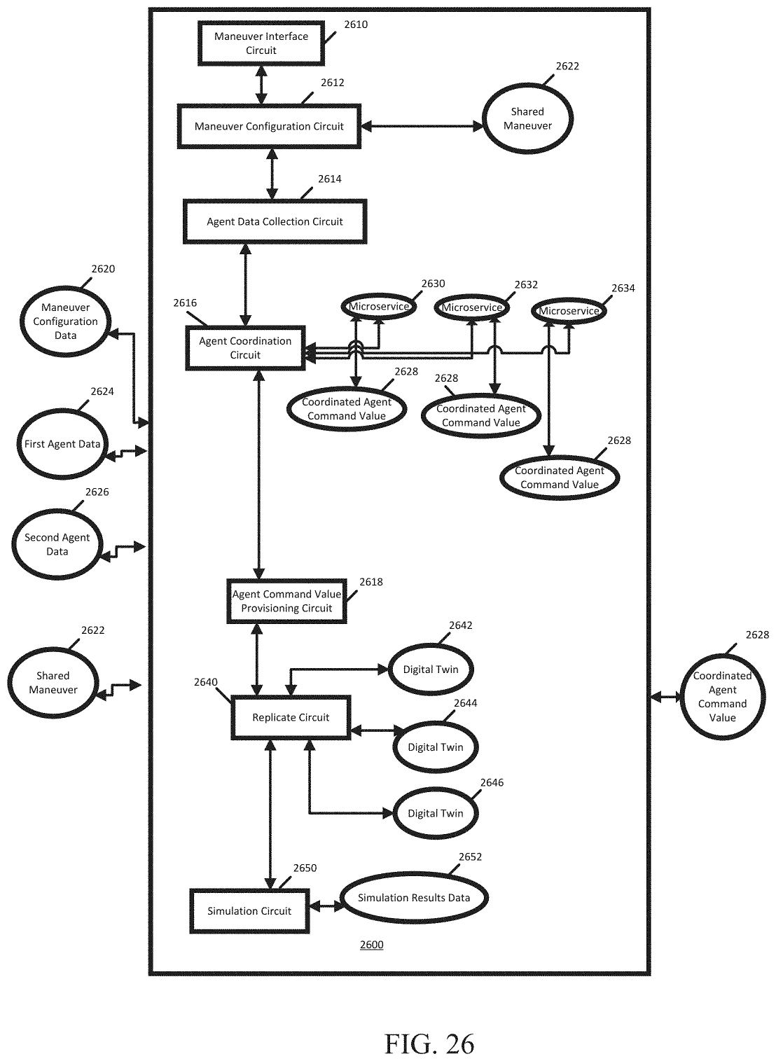

In embodiments, if the user interfaces with any point of interest on the map, e.g., the middle point 2210 in FIG. 22, the user may be provided with additional, detailed data, e.g., collected from the vehicle. In the non-limiting example of FIG. 24, the user may be provided with point cloud data of a powerline tower that has been inspected. In the non-limiting example of FIG. 25, the user may be presented with video imagery (e.g., automatically clipped video segment centered in time about the powerline tower selected) of a powerline tower that has been inspected. The user may review this data to determine if the automatically indicated anomaly or feature, e.g., indicated via computer vision, is accurate, noteworthy, etc.

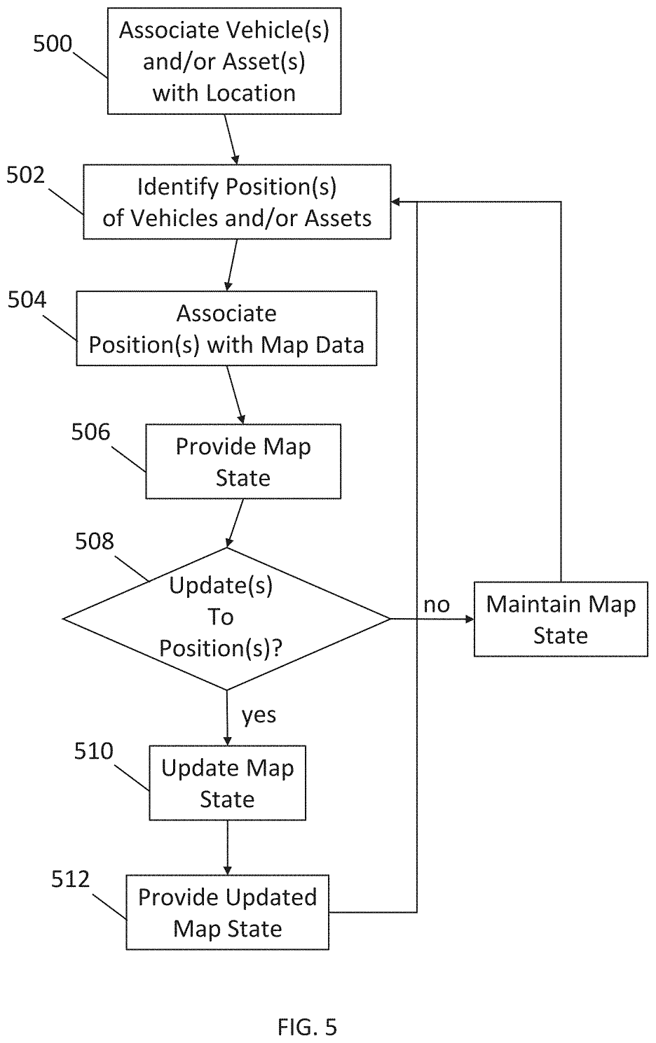

Referring now to FIG. 5, the platform may be utilized for traffic management, e.g., in a shared location such as location 108 of FIG. 1. This may provide for the platform to regulate traffic between devices and assets of various types. For example, all vehicles sharing a space or location may be required to conform to the platform communication requirements such that the platform enables or disables vehicle movement, similar to an air traffic controller.

For managing and/or coordinating vehicle traffic, the platform may maintain mapping state information for a covered location, such as location 108 (noting that the location may be any location where multiple manned or unmanned vehicles may travel, e.g., drone thoroughfares). In one non-limiting example, the platform 100 associates the vehicles with locations at 500 to have an inventory of vehicles at or planned to enter the location during a given time frame. At 502, the platform 100 may identify the current positions of the vehicles in the space, for example using GPS coordinates, beacon systems, round trip communication times between vehicles, computer vision from one or more vehicles in the location already, etc. Thereafter, the locations of the vehicles may be associated with map data at 504, e.g., vehicle positions are plotted against a map of the location using the coordinates. This may provide a map state 506, which may be outputted and/or otherwise made available to interested subscribing or consuming devices, e.g., the aforementioned mobile application of an operator of a manned vehicle. At 508, any updates for the positions of the vehicles may be determined and, if any, may be used to update the state of the location map at 510. Updates to the map state may be provided for example by the vehicles, including shared perception, e.g., of the location of an asset. If there are no changes, the map state may remain unchanged. The updated map state may likewise be provided, as indicated at 512.

In embodiments, a subscriber or consumer of the map states may be a routing and scheduling module provided by the platform 200. For example, a routing or scheduling module may queue requests for routes within a shared location, e.g., location 108. By way of non-limiting example, devices 102, 103, and/or 104 may have each requested routing instructions per a mission. It will be understood, however, that each device 102, 103, and/or 104 may be required to communicate the intent to perform the mission, e.g., in the form of a mission request, which is received by the platform 200, e.g., as indicated at 402 of FIG. 4. The platform 200 may process the requests, e.g., as indicated at 404, 406, and 408 of FIG. 4, and coordinate the various requests from the devices 102, 103, 104 to ensure that each has a successful mission, while avoiding interference with one another and any other vehicles, e.g., vehicle 106.

As shown in FIG. 1, a vehicle 102 may have its mission or task data, e.g., routing or scheduling data, adjusted such as by the platform or as part of an autonomous agility capability, e.g., programmed collision avoidance, intelligent efficient routing or task prioritization, etc. For example, platform may identify that vehicle 106 is collocated with a route 116 needed by vehicle 102 and, in response, adjust the route for the vehicle 102. Depending on a rule or rule set, e.g., that route 116 must be followed, the scheduling data for vehicle 102 may be changed by the platform 100, 200, 300 or otherwise, e.g., by device 102 and/or device 106, rather than the routing data, e.g., vehicle 102 may be delayed (or have a part or segment of its mission delayed or adjusted) or, if vehicle 102 is prioritized over vehicle 106 (or missions or assets associated therewith), vehicle 106 may be instructed to move temporarily to allow vehicle 102 to pass, even if this interrupts the mission of vehicle 106. In some embodiments, unmanned vehicles may be configured to respond to human provided movements with priority, e g , unmanned vehicles may defer to the movements of manned vehicles. In certain examples, missions or parts thereof may be adjusted based on vehicle or operator capabilities or expected actions, e g , manned and unmanned vehicles may be configured to adjust mission tasks or parameters thereof such as speed to accommodate a manned vehicle's acceptable or desirable operating parameters, an unmanned vehicle may be configured to update its map state to accommodate expected travel time, location and reaction for manned vehicles, etc.

Referring again to FIG. 1, vehicles 103 and 104 may have requested use of route 116 after vehicle 102 and be of equal priority to vehicle 102 (e.g., in terms of mission, vehicle (such as power status, usable window, etc.)) and/or other parameter used to prioritize. As such, the platform 100 may coordinate vehicles 102, 103 and 104 along with vehicle 106 using the current and/or projected map states. For example, if vehicle 102 has its route changed from 116 to 126, vehicles 103 and 104 may simply need to wait for vehicle 106 to clear route 116 and proceed sequentially (e.g., using first-in-first-out timing, priorities, etc.) or be assigned alternate routes that do not conflict with vehicles 102 and 106. In embodiments, the routing or scheduling data may be automatically adjusted. In embodiments, the routing or scheduling data may be semi-automatically adjusted, e.g., highlighting or indicated routes, missions or mission parts that need operator attention. In embodiment, some or all of the routing and/or scheduling data may be manually adjusted.

In certain aspects, prioritization may be utilized by a coordinating agent such as the platform 100, vehicles, or agents to determine how vehicles are to be coordinated to perform a mission, and/or where a mission may take a variety of forms. For example, in an embodiment, a first profile may be associated with a vehicle or agent, such as a standard profile. A second, third or any number of additional profiles or parameters of a profile may also be associated with a vehicle or agent, e.g., based on context data such as goal (current, future or a combination thereof), time, location, payload, cargo, other proximate vehicles, route availability, etc. Thus, as will be appreciated, profile(s) associated with a vehicle may be abstracted at various layers and updated dynamically to include a hierarchy of information, for example ordered by importance or preference related to a mission type goal, such as efficient delivery, cargo type, fuel economy, safety, etc. By way of a non-limiting example, if a mission includes transit of a passenger car or other vehicle through a smart city, a coordinating agent, e.g., platform 100, may obtain the passenger car's profile to determine its priority with respect to vehicles currently on a proposed route through the city or vehicles that are scored as reasonably likely to be encountered, e.g., based on historical data or planned mission data for those vehicles. Using such information, and similar information obtained from other vehicle profiles, the coordinating agent may prioritize the various vehicles for movement through the smart city. In another non-limiting example, this profile and routing data may be updated, e.g., during the transit of the passenger car through the city. In certain aspects, the passenger car's priority or route may be adjusted by entry of an unexpected, higher priority vehicle, such as an emergency vehicle, entering or anticipated to enter the passenger car's route.

Accordingly, in certain embodiments the profile data may be examined at different levels of a hierarchy such as intent or goal, vehicle or cargo type, etc., to make a determination related to prioritization. This may provide for coordination of complex vehicle systems to achieve a prioritized characteristic such as maximizing goal achievement, safety, efficiency, etc.

In embodiments, the platform 100 may be utilized in combination with various additional systems, such as an external system. For example, as shown in FIG. 1, the platform 100 may be configured to communicate with one or more remote devices 128, such as an ERP, CRM or logistics software system. This may provide for the platform 100 to implement workflows that utilize external system data and/or report data to external systems.

In another non-limiting example, similar to coordination of communication between vehicles, the platform 100 may act to coordinate location specific logistics data from a variety of locations. For example, a port operator may utilize the platform to coordinate logistics data for multiple locations, e.g., Location A-Location N of FIG. 1, where platform 100 acts to intelligently update logistics data such as the location of assets-based access to data reported from vehicles, operators, etc. at each location. As will be appreciated, this may provide for logistics data to be coordinated with cross-location missions and/or offer an end-to-end control and tracking capability.

In yet another non-limiting example, similar to coordinating communication between vehicles, the platform 100 may coordinate disparate systems, e.g., a CRM and ERP systems from different vendors or using records of different types. For example, an ERP system may provide inventory and logistics records, whereas a CRM system may provide other record types, such as sales of the inventory, etc. The platform 100 may be configured to communicate with both the ERP and CRM system and facilitate intelligent records updates. In embodiments, the platform 100 may determine that a mission has relocated an asset that has been sold, such as container 112 of FIG. 1. Following such an event, the platform 100 may communicate this data to an ERP system to update the inventory location or count record. Similarly, the platform 100 may communicate this data to a CRM system to update a sales record. In certain aspects, the platform 100 may respond to records or other data events in external systems such as ERP and CRM systems, e.g., initiate an inventory relocation mission based on a sales record update from a CRM system.

In embodiments, a remote device 128 such as an ERP or logistics system may include data related to assets, such as containers 112, 114 for tracking their location, status, and planned movements according to a business workflow or process. In this regard, the platform 100 may have access to or participate in forming the business workflow process, e.g., by providing map state data, such as the kind generated in a process similar to that outlined in FIG. 5, to the external system or incorporating data from the external system into a map state. Accordingly, a user may plan a mission such as moving a container, e.g., container 112, 114 from one place, e.g., in a port, to another, e.g., loaded onto a truck, per a business workflow or process that forms part or all of a mission plan. During the planning, the platform 100 may act to facilitate the formation of the business workflow or process, e.g., by identifying one or more vehicles, e.g., vehicles 102, 103, 104 or 106, that are available for use in the location 108, capable of performing the business workflow or process, etc. During performance, the platform 100 may act to track and update the progress of the business workflow or process, e.g., by providing updated map state information that corresponds to performance or completion of a mission part, a workflow, and/or a stage thereof. For example, upon completion of a mission part, e.g., sending a vehicle to pick a container such as container 114, the platform 100 may update its map state, as outlined for example in FIG. 5, and thereafter trigger a data output, such as in indication or an alert, to an external system, e.g., remote device 128, which may be an ERP or logistics application server hosting associated software. As such, users and/or subscribers of the ERP or logistics application provided by remote device 128 may be notified or kept up to date with the mission progress, any difficulties encountered, etc. As will be understood, in embodiments, a mission stage and/or workflow stage may be segmented, e.g., divided into one or more sub-stages, based at least in part on real-time dependency requirements and/or human limitations. For example, a workflow for loading goods from a warehouse to a ship, which in the absence of human real-time limitations, may have a load stage that can be carried out at a speed and fluidity exceeding human capable interaction, e.g., the blockchain transactions of such a workflow may be the only requirement to proceed throughout the workflow where some embodiments may employ a blockchain consensus algorithm, e.g., Tendermint (to include “Tendermint core” also abbreviated herein as “tmint”), which may process 1000s of transactions/second. In the presence of real-time dependency requirements and/or human limitations, however, the load stage may be divided into multiple load sub-stages separated by wait sub-stages, wherein the wait sub-stages provide time for a human forklift operator to finish a prior load sub-stage.

In some embodiments, workflows or missions may be scheduled, e.g., to take place at a specific time, to recur, to begin after completion of a related mission or detection of the presence of an object such as cargo being situated in a given location, such as detected using computer vision and object detection. Accordingly, platform 100 may be used to coordinate workflows or missions with one another, e.g., to offer 24-hour automated processes even when employees are not available to plan, trigger or update missions, such as at small and medium businesses or operations in harsh environments. In some embodiments, a workflow may be triggered by an external system, e.g., a CRM or ERP system, for example a workflow may be started by receipt of data by platform or another system component from an external system. In embodiments, a workflow may be requested by real-time microservices, wherein task/workflow assignment may be a core service of one or more sentry nodes. As will be understood, a sentry node, also referred to herein as a “sentry”, may be a blockchain node that is observable by agents. Sentry nodes may run/execute an Application Blockchain Interface (ABCI) application (which may interface with a consensus engine such as Tendermint) but may not be part of the validator set that finalizes consensus. Thus, in embodiments, sentry nodes may provide a secure layer of nodes to separate agents from blockchain validators.

Depending on the nature of the implementation, more than one location may be managed by the platform 100 and data associated therewith may be provided to one or more external systems. This permits the platform 100 to act as an intermediate not only for device communications but also to integrate third-party or external software systems that have an interest in receiving updates from the platform 100 or providing data to the platform 100.

In embodiments, external systems may be utilized in the form of different vehicle types, e.g., vehicles involved in a mission, vehicles in a mission environment but not specifically tasked with the mission, etc. For example, the platform 100 may make mission data available to a set of vehicles in the mission environment irrespective of their involvement in the mission. In certain aspects, this may be done to provide a redundant or proximate source of mission data, e.g., permitting other vehicles to act as a source of mission information for proximate vehicles. In other aspects, vehicles not engaged directly with the mission but located in the environment may utilize real time sensed data or communication data, such as from vehicle(s) directly involved in the mission, to respond in an events-based manner For example, vehicle(s) associated with a mission may request or offer aid or assistance with a mission or part thereof. Thus, vehicles aware of the mission, in the proximate environment, but not directly involved in the mission, may become associated with the mission or mission part dynamically. In embodiments, such assistance may take the form of communicating mission data, updating mission data, providing real-time sensor data, taking over a mission part, or otherwise offering assistance to the vehicle requesting assistance with mission completion based on inability to perform, e.g., identify an asset associated with a mission task such container 112.

As will be appreciated, in embodiments, the platform 100 and/or device communications associated with the platform or coordinated vehicles/agents may be secured to ensure that the platform 100 is robust against malicious actors. For example, an unmanned vehicle should be certain that mission instructions received are from a trusted source.

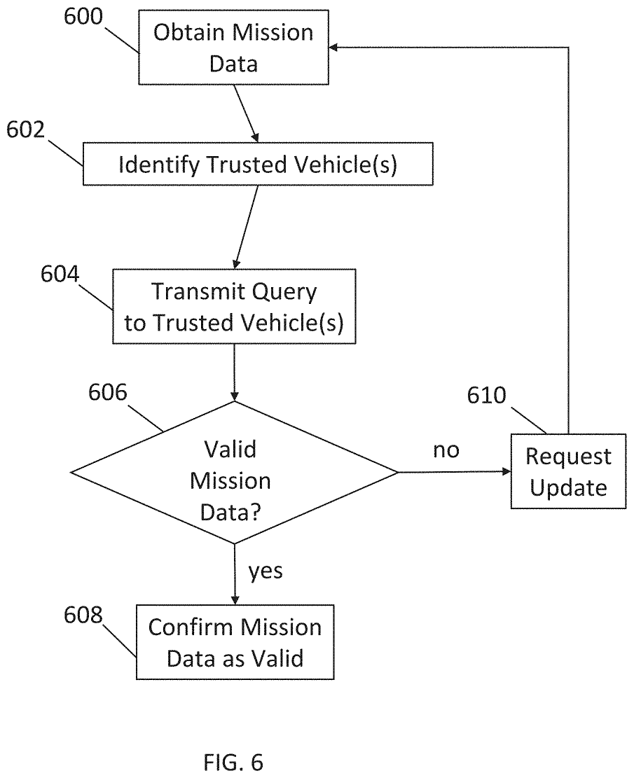

Accordingly, as shown in FIG. 6, a vehicle, e.g., an unmanned drone such as vehicle 102 of FIG. 1, may obtain mission data at 600, e.g., receive instructions addressed to it purportedly from the platform 100. The unmanned vehicle may validate the mission data by identifying a trusted source at 602, e.g., a trusted unmanned vehicle or external system. Trust may be established in a variety of ways, e.g., use of a proprietary communication protocol utilized by a device type and not used by platform, via certificate, etc.

Thereafter, the unmanned vehicle may transmit a query to the trusted source at 604, e.g., communicate with another unmanned vehicle, e.g., inquiring as to whether the mission data is valid and has been received by that vehicle as well. In response, the trusted source may reply, and as indicated at 606, and the first unmanned vehicle may determine if the mission data is valid, confirm this at 608 for use, or discard it with a request for an update, as indicated at 610.

In certain aspects, the trusted source may take a variety of forms, e.g., a blockchain or distributed ledger that holds authentic mission data and is maintained by a fleet of unmanned vehicles, a source mission information, such as an external ERP system, etc. The mission data stored in such a trusted source may be encrypted to protect it from visibility by unauthorized sources. As will be appreciated, the trusted source may also be used to validate updates to agents, e.g., vehicles, robots, etc. Such updates may be provided via a hard-wire connection, e.g., a LAN line, over-the-air (OTA), and/or via other electronic communication methods. For example, in embodiments, a digital ledger may be used to track and validate updates to an autonomous forklift where other agents, who may need to interact with the forklift, can verify that the forklift has the most recent software updates for its particular type, model, location, mission, communication protocols, etc.

Referring back to FIG. 3, a variety of architectures may be chosen for a given implementation. For example, as shown in FIG. 3, a local network 302 may be used, e.g., in a port implementation where communication efficiency and security are characteristics to be maximized This may provide for use of a mixed fleet of vehicles 304, 306, 308, 310 in combination with respective device core 312, to consume microservices offered (in this non-limiting example) via local server(s) of the local network 302. If distributed ledger technology (DLT) is incorporated, e.g., via use of a decentralized network of nodes 314, a decentralized implementation of smart contracts may be implemented, providing an extensible replicated logic method/process to incorporate into tasks and/or workflows, and permitting a bidding marketplace for tasks of workflows.

In embodiments, the trusted source for data referred to in the example of FIG. 6 may be a blockchain or distributed ledger that holds additional or alternative mission related data. For example, a distributed ledger may be utilized by the vehicles, platform, users and combinations thereof, to engage in a secure trading of services or resources. By way of a non-limiting example, the platform 300 or microservices provided via a local network 302 may provide a mission (or parts thereof) to a distributed ledger implemented in a decentralized network of nodes 314, with or without vehicle or agent assignments. In embodiments, if vehicle(s) have not been assigned to mission part(s), vehicle(s) or agent(s) may bid on the mission parts, e.g., based on availability, capability, location, etc. In certain aspects, the platform 300 or microservices provided via a local network 302 may decide an assignment based on the bid(s) and/or the vehicles may reach a consensus. For example, a decentralized application (DAPP) 316 may be provided and permit end users and/or automated agents e.g., devices 304, 306, 308, 310, or a combination thereof, to review and/or bid on unassigned tasks. In such embodiments, the automated agents may be programmed to bid automatically on certain tasks or task types, at certain availability windows (statically programmed or dynamically determined, e.g., based on location, availability, economy, etc.), or a combination of end users and automated agents may participate in the bidding marketplace by an acceptable interface with the decentralized network 314.

In embodiments, a digital ledger, e.g., blockchain, may be used for key management of digital twin identities, tasks, and/or workflow instructions. In embodiments, keys may be passed from a blockchain to a global data space of data distribution system deployments, which, in some embodiments, may provide for seamless security. Some embodiments may utilize an application specific blockchain, e.g., Tendermint, which may provide for the provisioning of services and/or the building of logic beyond a traditional digital ledger. Such embodiments may further utilize ABCI to build an application which connects to a consensus core of a consensus engine, e.g., Tendermint.

In embodiments, transactions in the digital ledger may correspond to tasks and/or workflows performed on the digital ledger. Tasks may include one or more details and/or actions, as described herein, which may be constructed in a replicated compute environment and/or connected to a next stage apart of a larger workflow, as also described herein. In embodiments, task instructions, e.g., directions for performing the task, may be delivered to one or more agents and/or microservices (that are participating in the task) in a decentralized manner in preconfigured data spaces.

In certain scenarios, e.g., if missions or parts thereof have been assigned to vehicles or agents, or assignments have been decided based on bidding, the vehicles and/or agents may securely exchange and/or barter the services to re-assign the services. For example, a given vehicle may trade and/or exchange a mission part with another vehicle based on cost, availability, capability, etc.

By way of non-limiting example, and referring to FIG. 3, in the case where a shipping port is orchestrating pickups of containers by dredge trucks, the shipping port may have the same requirements to limit cloud connectivity, but has shipping arrivals coming in remotely, and the dredge trucks may be required to end the port workflow with pickup of containers from a remote provider. As described herein, embodiments of the current disclosure may provide for a workflow builder and/or tool that may be utilized by an end user, e.g., port operator or employee, to build an end-to-end workflow. In certain aspects, e.g., associated with a task to be bid on the decentralized network 314, the workflow builder may be used to configure such processing. For example, a user may indicate that the best available device or agent should handle a pickup step, including remote (off-port) devices, as determined by a bidding process facilitated by the decentralized network 314. This may provide for the user to build the workflow without explicitly picking a device. In some examples, the user may indicate preferences and/or requirements (e.g., reputation score, cost or reward given, vehicle class or type, etc.). Once the user has completed forming the workflow, it may be processed by the system, e.g., to identify parts that may be sent directly to specified devices or agents, and/or parts directed for bidding on the decentralized network 314, etc. In this way, bidding marketplace DAPP 316 may take the form of a workflow builder and/or include a workflow builder module. Additionally, or alternatively, a workflow builder may communicate data, e.g., tasks of a workflow for bidding, to the bidding marketplace DAPP 316.

To complete end-to-end automation of the whole workflow process, remote, off-chain data 318 or feeds (such as container schedules) may be pipelined through a decentralized network (not shown in FIG. 3) to first validate the message. Once validated, a container schedule may be published (e.g., indicating which container is to be picked up first, its destination, and the reward for delivering it to its final destination, such as digital currency) as a task request listed on the decentralized application 316 and placed on the decentralized network 314. This may provide for the task to be viewed in the decentralized network 314, e.g., using the bidding marketplace DAPP 316, and be bid upon by agents on the decentralized network 314, etc. Once a bid is won, the system, e.g., microservice running in local network 314, may manage the exchange required to complete the tasks bid upon, as well as reward the remote (non-port) but trust-validated agent on the decentralized network 314 for taking and completing the task.

In summary, data security and availability may be enhanced by deploying a distributed ledger technology such as blockchain for verification of mission commands across fleets of trusted nodes. Because embodiments may utilize various architectures, e.g., the system can operate on a point-to-point (PTP) and peer-to-peer (P2P) basis, the system may enable functional coordination and trusted engagement. As will be understood, by providing for trusted engagement, embodiments of the platform 100, 200, 300 may mitigate and/or eliminate the risk of spoofing attacks against an industrial facility, e.g., an agent, e.g., a worker, can be sure that if they are instructed to leave a forklift and/or a container (with valuable cargo) at a particular location, that the instructions to do so came from a trusted source. Fleets under the control of and/or compliant with the system can exchange tasks and services with other agents by submitting proposals to be bid upon. The marketplace may host needed tasks to complete workflows within shared and open operating environments. As will be appreciated, the system may verify off-chain data (e.g., transaction related data, e.g., container schedules, reputational data, e.g., of remote agents wanting to participate in use of the bidding marketplace DAPP 316, and the like) by passing it through a decentralized network (such as CHAIN LINK).

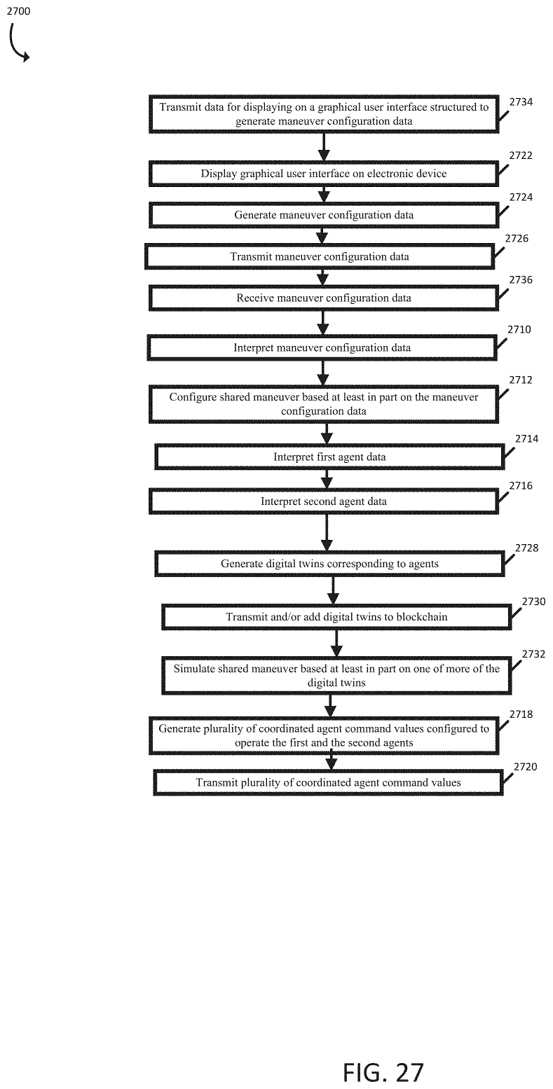

Illustrated in FIG. 26 is an apparatus 2600 for orchestrating a plurality of agents, e.g., vehicles, microservices, and/or other devices as described herein. The apparatus 2600 may form part of the platform 100, 200, 300 and/or any other computing device described herein, e.g., the apparatus 2600 may be one or more processors of one or more servers (or other computing devices) of the platform 100, 200, 300. In embodiments, the apparatus 2600 includes a maneuver interface circuit 2610, a maneuver configuration circuit 2612, an agent data collection circuit 2614, an agent coordination circuit 2616, and an agent command value provisioning circuit 2618.

The maneuver interface circuit 2610 is structured to interpret maneuver configuration data 2620. Non-limiting examples of maneuver configuration data include a mission identifier, a task identifier, a listing of one or more asserts involved in the mission and/or task, devices/agents available to perform the mission and/or task, locations involved with the mission and/or task, and/or other types of data concerning the details of the mission and/or task as described herein. In embodiments, the maneuver configuration data may be generated by either a human (using an electronic device as described herein) and/or by a nonhuman agent, e.g., a robot or other AI system. For example, an agent, e.g., a ship, may make a request, via the platform 100, 200, 300, that it be unloaded by a particular date and/or time.

The maneuver configuration circuit 2612 may be structured to configure a shared maneuver 2622 for the plurality of agents based at least in part on the maneuver configuration data 2620. In embodiments, a shared maneuver may be a mission or task performed in a location where multiple agents are operating. The mission or task may be performed by two or more agents. Non-limiting examples of shared maneuvers include loading a cargo ship, unloading a cargo ship, transporting goods through a supply chain, cleaning a location, performing maintenance on equipment, and/or other types of missions or tasks described herein. In embodiments, the maneuver configuration circuit 2612 may include a task assignment microservice that can be deployed to one or more nodes/levels of the platform 100, 200, 300.

The agent data collection circuit 2614 is structured to interpret first agent data 2624 and second agent data 2626. The first agent data 2624 corresponds to a first agent of the plurality of agents and the second agent data 2626 corresponds to a second agent of the plurality of agents. The first 2624 and second 2626 agent data may include: location; agent type; capabilities, e.g., speed, weight carrying capacity, etc.; availability; operating costs, and/or any other agent properties. The first 2624 and second 2626 agent data may be used to generate and/or update digital twins corresponding to the first and second agents, as described herein.

The agent coordination circuit 2616 may be structured to generate a plurality of coordinated agent command values 2628 configured to operate the first and the second agents based at least in part on the configured shared maneuver 2622, the first agent data 2624, and/or the second agent data 2626. Non-limiting examples of agent command values 2628 include route information, scheduled departure and arrival times, asset identification information, and/or other types of data for assisting the agent in performing the shared maneuver. In embodiments, the agent coordination circuit 2626 may be further structured to generate a plurality of microservices 2630, 2632, 2634, as described herein. In such embodiments, one or more of the microservices, e.g., microservice 2630, may generate the plurality of coordinated agent command values 2628. In certain aspects, coordinated agent command values 2628 of the plurality generated by different microservices may be of different types, e.g., a first microservice may be tasked with coordinating recharging of electrical vehicles that perform aspects of the shared maneuver and a second microservice may be tasked with deconflicting the electrical vehicles (among themselves and/or with other vehicles) along one or more routes utilized by the electrical vehicles for performing the shared maneuver. As such, in embodiments, at least one of the plurality of microservices 2630, 2632, and/or 2634 corresponds to traffic deconfliction for the plurality of agents, traffic prioritization for the plurality of agents, or execution of a mission or a task by one or more of the plurality of agents. In embodiments, one or more of the microservices 2630, 2632, 2634 may perform one or more of the following: monitor fuel consumption for an agent, perform rerouting of an agent to account for planned and/or unplanned circumstances, e.g., bathroom breaks, supply chain delays, equipment malfunctions, weather events, etc. In embodiments, the agent coordination circuit 2616 may include one or more assignment microservices that assign optimal tasks to agents (identified for a mission) and create a data distribution service (DDS) network for the mission's agents to cooperatively work on and/or share information across. In embodiments, microservices may bid on tasks, akin to how agents may bid. In embodiments, a mission may have a variety of microservices for accomplishing the full mission end-to-end, wherein the microservices may be spun up on a same data distribution service (DDS) network.

The agent command value provisioning circuit 2618 may be structured to transmit the plurality of coordinated agent command values 2628. Transmission may be to another apparatus, e.g., processor, and/or agent, and may be accomplished via one or more communication channels as described herein, e.g., the DDS network.

In embodiments, the apparatus 2600 may further include a replicate circuit 2640 structured to generate one or more digital twins 2642, 2644, 2646, as described herein. Each of the one or more digital twins 2642, 2644, and/or 2646 may correspond to a different agent of the plurality of agents. In certain aspects, the agent coordination circuit 2616 may be further structured to generate the plurality of coordinated agent command values 2628 based at least in part on one or more of the digital twins 2642, 2644, and/or 2646.

In embodiments, the apparatus 2600 may include a simulation circuit 2650 structured to simulate the shared maneuver 2622 as described herein. As will be understood, such simulation may encompass all or part of the shared maneuver 2622. The simulation may be based at least in part on one or more of the digital twins 2642, 2644, 2646. In embodiments, the agent coordination circuit 2616 may be further structured to generate the plurality of coordinated agent command values 2628 based at least in part on the simulation of the shared maneuver 2622. For example, the simulation circuit 2650 may generate simulation results data 2652 that is fed to the agent coordination circuit 2616. Non-limiting examples of simulation results data 2652 include route data for each of the simulated agents, prioritization data for each of the agents, timing data, an expected duration for completing the shared maneuver, an expected completion time for completing the share maneuver, and/or any other type of data regarding the simulation.

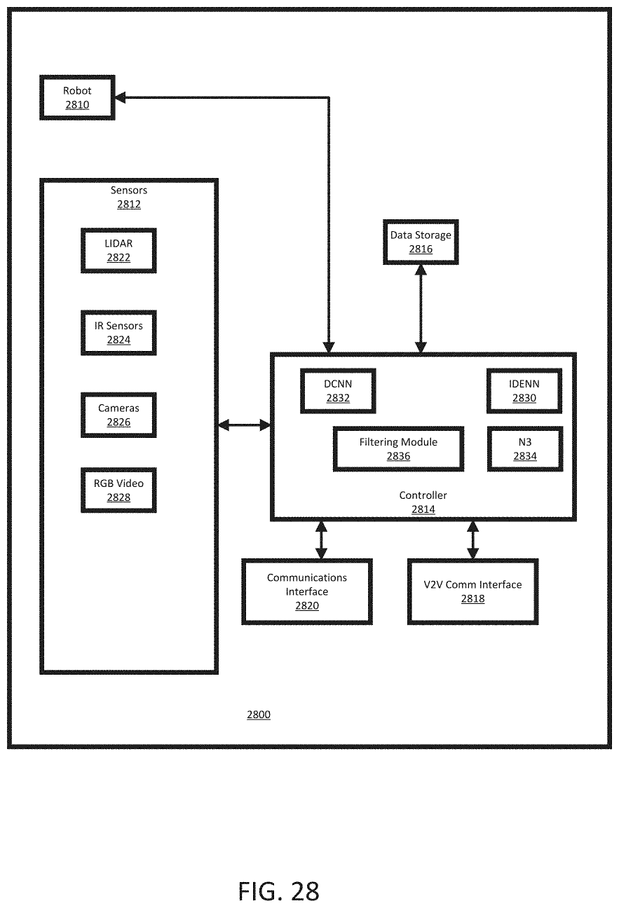

Referring now to FIG. 27, a method 2700 for orchestrating a plurality of agents, in accordance with embodiments of the current disclosure, is shown. The method 2700 may be performed by the apparatus 2600 (FIG. 26) and/or any other computing device described herein, e.g., the platform 100, 200, 300. As shown in FIG. 27, the method 2700 includes interpreting maneuver configuration data 2710, and configuring a shared maneuver for the plurality of agents 2712, which may be based at least in part on the interpreted maneuver configuration data. The method 2700 may further include interpreting first agent data 2714 and interpreting second agent data 2716. The first and second agent data may correspond to first and second agents, respectively, of the plurality. The method 2700 may further include generating a plurality of coordinated agent command values configured to operate the first and the second agents based at least in part on the configured shared maneuver, the first agent data, and/or the second agent data 2718. The method 2700 may further include transmitting the plurality of coordinated agent command values 2720. In embodiments, the method 2700 may further include displaying a graphical user interface on an electronic device 2722; and generating the maneuver configuration data via the graphical user interface 2724. Non-limiting examples of the electronic device 2722 include smart phones, tables, VR headsets, and/or any other type of computing device with a display. The method 2700 may further include transmitting the maneuver configuration data via the electronic device 2726. In embodiments, the method 2700 may further include generating one or more digital twins corresponding respectively to one or more of the plurality of agents 2728. The method 2700 may further include transmitting and/or adding one or more of the digital twins to a blockchain 2730. In such embodiments, generation of the plurality of coordinated agent command values 2718 may be based at least in part on the digital twin and the blockchain. Interactions between agents and/or microservices may be computed in replicated smart contracts on the blockchain. In embodiments, the method 2700 may further include simulating the shared maneuver based at least in part on the one or more digital twins 2732. In such embodiments, plurality of coordinated agent command values is based at least in part on the simulation of the shared maneuver. In embodiments, the method 2700 may further include transmitting data for displaying, on the electronic device, a graphical user interface structured to generate the maneuver configuration data 2734. The method 2700 may further include receiving, from the electronic device, the maneuver configuration data 2736.

In a non-limiting example, a dock/port worker may have a need to move a container from location A to location B. As such, the dock worker may open an application on an electronic device that displays a GUI, as described herein, for orchestrating a plurality of agents. The dock worker may then enter maneuver configuration information/data into the GUI, e.g., the container needs to go from location A to location B. The electronic device may then transmit the maneuver configuration information/data to the server/platform wherein the server, as described herein, generates agent coordination command values that inform the dock worker which assert, e.g., vehicle, to use to transport the container from location A to location B and which route to use.

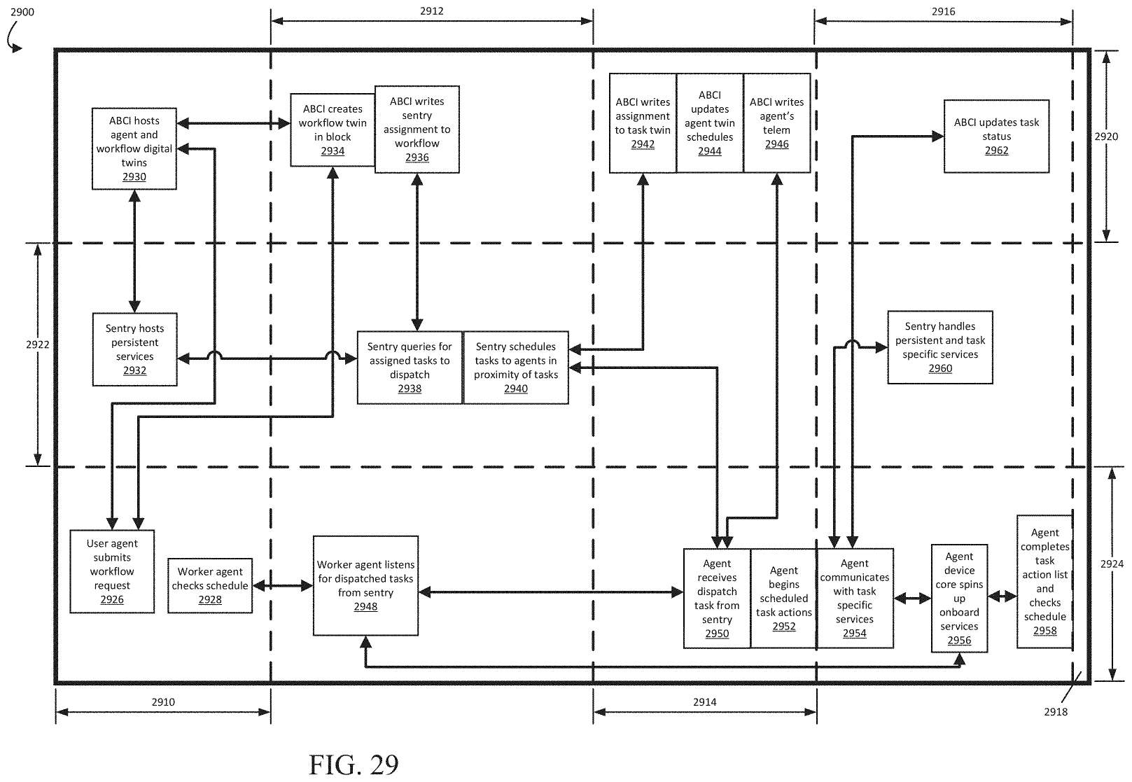

Illustrated in FIG. 28 is a schematic diagram of an agent, e.g., an autonomous vehicle 2800, in accordance with an embodiment of the current disclosure. Non-limiting exemplary components of the agent 2800 may include a robot 2810, various sensors 2812, a controller 2814, data storage 2816, a vehicle-to-vehicle (V2V) communication interface 2818, a communications interface 2820 for communicating with the platform 100, (FIG. 1), 200 (FIG. 2), 300 (FIG. 3) and other external entities via one or more of various types of networks.

The controller 2814 may include a processing element such as a GPU, floating point processor, AI accelerator and the like for performing vehicle and related data processing, including without limitation neural network real-time data processing. The vehicle may include other processing elements, such as a CPU for operations, such as sequencing and coordinating data, hosting an operating system, and the like.

The vehicle data storage 2816 may include non-volatile memory, such as solid state drives for storage (e.g., temporary, short term, long term, and the like) of captured data, uploaded data, data from other vehicles as well as storage of processed data. The sensors may include LIDAR 2822, IR sensors 2824, digital cameras 2826, RGB, and/or other video 2828 inputs/sensors, and other sensors such as thermal, stereo, hyper or multispectral sensors, or any other 2D, 3D, or other sensor, and the like, for data acquisition related to a mission and navigation of the vehicle. In embodiments, the platform 100, 200, 300 may be able to “stitch” together a map of the location, e.g., port facility, based on information collected by the sensors on the agents. For example, a first agent may provide data about a first region of a location and a second agent may provide information about a second region of the location. In embodiments, the platform 100, 200, 300 may be able to localize a 3D location of an asset, e.g., container, based on video footage provided by one or more agents of the asset.

The communication interfaces 2818, 2820 may include a high-speed data transmission connection interface (beyond the on-board connections) including USB, Ethernet, or the like for communicating with one or more other vehicles, the cloud platform, or other entities, as well as include components allowing for different types of data communication on different spectrum, which may include cellular data like LTE, WiFi, and proprietary systems such as satellite connectivity. The V2V communication interface 2818 for vehicle-to-vehicle communication may also allow for real-time coordination between vehicles.

In embodiments, the controller 2814 includes processing capabilities that may include artificial intelligence (AI) to sense an issue during its mission and determine an appropriate path adjustment. This sensing may trigger automated path planning to create a more in-depth look at a suspected issue site. This may be an incident detailed examination (IDE) procedure which may entail planning a circular path around the site where the sensors are capturing data which may be used to determine if the issue is a real issue and/or may be used to provide the data to the end user documenting the issue; for example, a vehicle inspecting an electric distribution system and determining that a utility pole has fallen over. In reaction to this event, the vehicle may collect additional data for the area surrounding the detected fallen utility pole, such as by moving closer and circling around the area to obtain data from additional viewpoints.

In embodiments, the controller 2814 may include an incident detailed examination neural network (IDENN) 2830, which may be used to detect relevant events and identify areas of interest relevant to a mission plan of the vehicle. The IDENN 2830 may be enabled to quickly (e.g., in near real-time) and efficiently (e.g., using fewer processing cycles than existing technology) process the data generated from the vehicle sensors (e.g., digital cameras 2826, LIDAR 2822, IR sensors 2924, and the like) and optionally from external sensors and/or data sources to detect issues during the vehicle's mission path. The IDENN 2830 can trigger a modification of a planned mission path to provide a closer and/or more in-depth look at an identified issue. The IDENN 2830 can then use the new data from the closer look to verify the issue, acquire more data if necessary, and create a data-capture report.

More specifically, in embodiments, upon determination of an incident or event, a data capture neural network (DCNN) 2832 may be activated. The DCNN 2832 may be used to provide a continuously improving data-capture that maximizes efficiency of the planned path geometry considering both the amount of data needed, the environmental conditions, and the optimal viewing angles of the sensors.

In embodiments, a navigation and path planning neural network (N3) 2834 may facilitate autonomous operation of the vehicle and its component systems. The N3 2834 may provide the ability for the vehicles to safely integrate into the airspace while ferrying and conducting missions. N3 2834 may receive external data from several sources, such as AirMap, NOAA, and the like, plus the mission requests from the cloud platform 100, 200, 300 to continuously plan and optimize routes.

The N3 2834 may receive communications from and transmit communications to other entities, such as air traffic control entities and/or other air traffic networks N3 2834 may facilitate aborting or rerouting any mission due to weather or other issues. The N3 2834 may plan and route a maintenance grounding. The N3 2834 may enable performance of emergency maneuvers based on input from sensors. The N3 2834 may enable performance of emergency maneuvers based on input from onboard maintenance systems. The N3 2834 may act to optimize missions based on efficiency of operation of onboard solar-electric system. The N3 2834 may act to optimize a path using a combination of thrust, brake, wind speed, direction and altitude.

In embodiments, the agent 2800 may include an intelligent data filtering module 2836, which acts to determine which dataset to provide as useful information to the end-user, which may be important for the vehicle autonomy perception, and determining which data should be added to various training sets shared amongst vehicles. In embodiments, the data filtering module 2836 may compare stored data on the vehicle to the available current or expected bandwidth on available spectrum in order to determine how much and what types of data to send. The vehicle may classify data in order to prioritize the data to transmit. This includes during mission and transit opportunities. Mission path planning also may incorporate the need to transmit data and network availability.

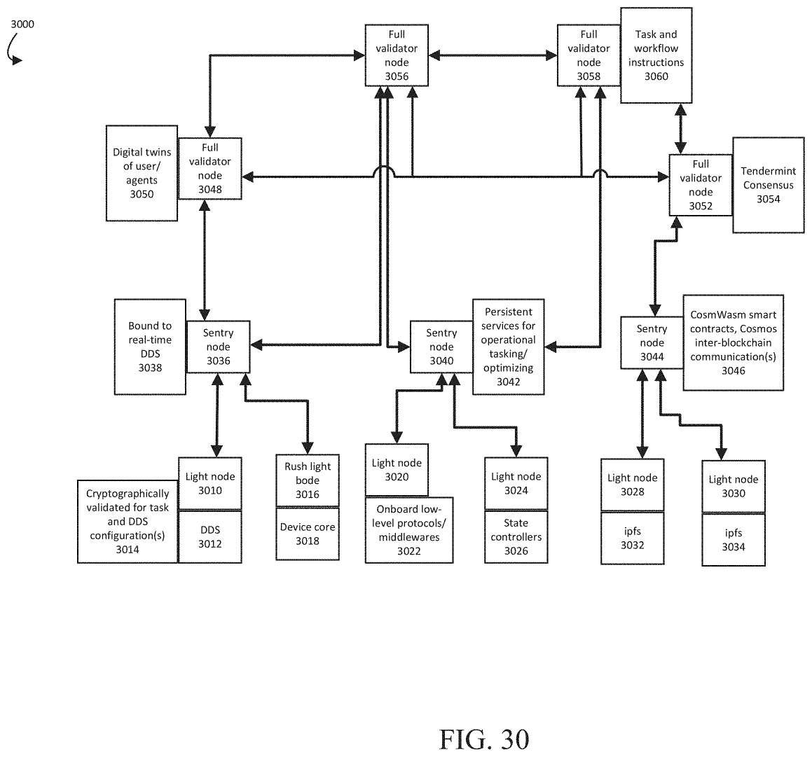

Illustrated in FIG. 29 is a non-limiting example of a workflow 2900 depicting the assignment and completion of a task to an agent in accordance with the current disclosure. The workflow 2900 may have one or more stages, e.g., a pre-workflow submission stage 2910, a workflow submitted stage 2912, a task assigned stage 2914, a task begin stage 2916, and/or a task complete stage 2918. In embodiments, each of the one or more stages may include one or more sub-stages. Processes within the workflow 2900 may constitute one or more of: replicated logic 2920, e.g., the copying, recording, and/or other preservation of events occurring within the workflow 2900; real-time logic 2922, e.g., procedures performed in real-time; and/or onboard logic 2924, e.g., procedures performed onboard an agent, e.g., a drone.

As shown in FIG. 29, a user agent may submit a workflow request 2926. A worker agent may then check a schedule 2928. An ABCI application may host an agent and/or one or more digital twins that receive the workflow request 2930. The ABCI application, hosted agent and/or the digital twins may communicate with one or more services, which may be persistent and/or hosted by a sentry 2932. The ABCI application may then create a workflow twin 2934. The ABCI application may then write the sentry's assignment to the created workflow 2936. The sentry host may then execute queries to determined assigned tasks to dispatch 2398 and subsequently schedule one or more tasks to agents 2940, which may be based at least in part on an agent's proximity to the task, e.g., closeness to an asset/object and/or a better position to execute the task than other agents. The ABCI application may then write assignments to a task twin 2942, update agent twin schedules 2944, and/or write the tasked agent's telemetry 2946, also referred to herein as “telem”.

As further shown in FIG. 29, a worker agent may be listening for dispatched tasks from the sentry 2948 until it receives a dispatched task from the sentry 2950. Upon receiving a task, the worker agent may begin performing one or more scheduled task actions 2952. During performance of the one or more task actions, the tasked agent may communicate with one or more services and/or microservices 2954, as described herein, that may be specific to the task. An agent device core may also spin-up onboard services 2956 for completing one or more of the task actions. In accordance with the processes described herein, the agent completes the one or more task actions 2958, the overall task, and/or one or more task actions on a list, and may further check the schedule. In embodiments, the sentry may handle persistent and/or task specific services 2960. The AI host may also update the status of the task, and/or corresponding actions 2962.

Embodiments of the system for orchestrating a plurality of agents, in accordance with an embodiment of the current disclosure, may include one or more architectures which may include one or more groups of digital objects. For example, embodiments of the current disclosure may provide for an open ecosystem for secure tasking and disparate system collaboration. Such embodiments may have an architecture with a first group of digital objects that includes one or more of: validator nodes; digital twins; tasks; workflows; keys; ABCI objects and services; smart contracts; etc. The architecture may have a second group of digital objects that includes one or more of: sentry nodes; persistent services; cross fleet optimization services; open task assignments; real-time microservices; persistent file sharing, e.g., open ipfs data; and/or telem filters/relays; etc. The architecture may have a third group of digital objects that includes one or more of: light nodes; agents; services; human users; fleet private ipfs networks; cryptographic validation of assignments; services for orchestrating across-pre-configured keys for real-time data distribution spaces; etc. In embodiments, the objects within the foregoing groups of the architecture may communicated with each other.

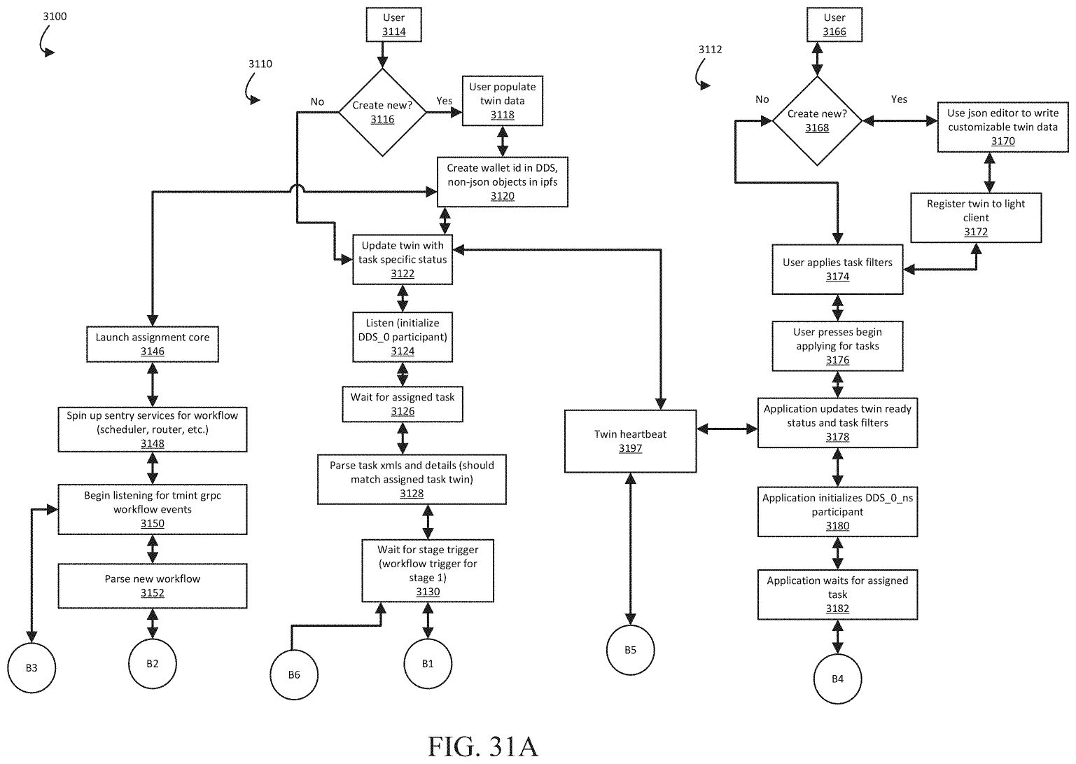

Shown in FIG. 30 is a non-limiting example of another architecture 3000 for a system for orchestrating a plurality of agents, in accordance with embodiments of the current disclosure. The architecture 3000 may include a light node 3010 that implements and/or uses a DDS microservice 3012. The light node 3010 may access, via the ABCI and/or a consensus engine, e.g., Tendermint, one or more cryptographically validated tasks and/or DDS configuration(s) 3014. As will be appreciated, the use of light nodes by some embodiments may provide for the sending and/or receiving of transactions in a decentralized, cryptographic manner without running/spinning up a full node. In embodiments, the light nodes, as disclosed herein, may be based at least in part on a Merkle tree decomposition method. The architecture 3000 may include a rush light note 3016 that accesses and/or provides device core services 3018, and/or a light node 3020 that accesses and/or provides onboard low-level protocols/middleware(s) 3022. The architecture 3000 may include a light node 3024 that accesses and/or provides state controller services 3026. The architecture 3000 may include one or more light nodes 3028 and/or 3030 that provide and/or access shared file systems 3032 and/or 3034. Nodes 3010 and/or 3016 may communicate with a sentry node 3036 that may be bound to a real-time DDS 3038. Nodes 3020 and 3024 may communicate with a sentry node 3040 that provides and/or accesses persistent services for operational tasking/optimizing 3042. Nodes 3028 and 3030 may communicate with a sentry node 3044 that provides and/or accesses smart contracts 3046, e.g., CosmWasm smart contracts. In embodiments, smart contracts may be replicated logic that, when called by a node connecting through a sentry node, run/execute on multiple nodes and must reach consensus. Sentry node 3036 may communicate with a full validator node 3048 that accesses and/or provides digital twins of users and/or agents 3050. Sentry node 3044 may communicate with a full validator node 3052 that accesses and/or provides an application replicator 3054, e.g., Tendermint. Nodes 3036, 3040, and/or 3052 may communicate with full validator nodes 3056 and/or 3058, wherein node 3058 may access and/or provide for task workflow instructions 3060.

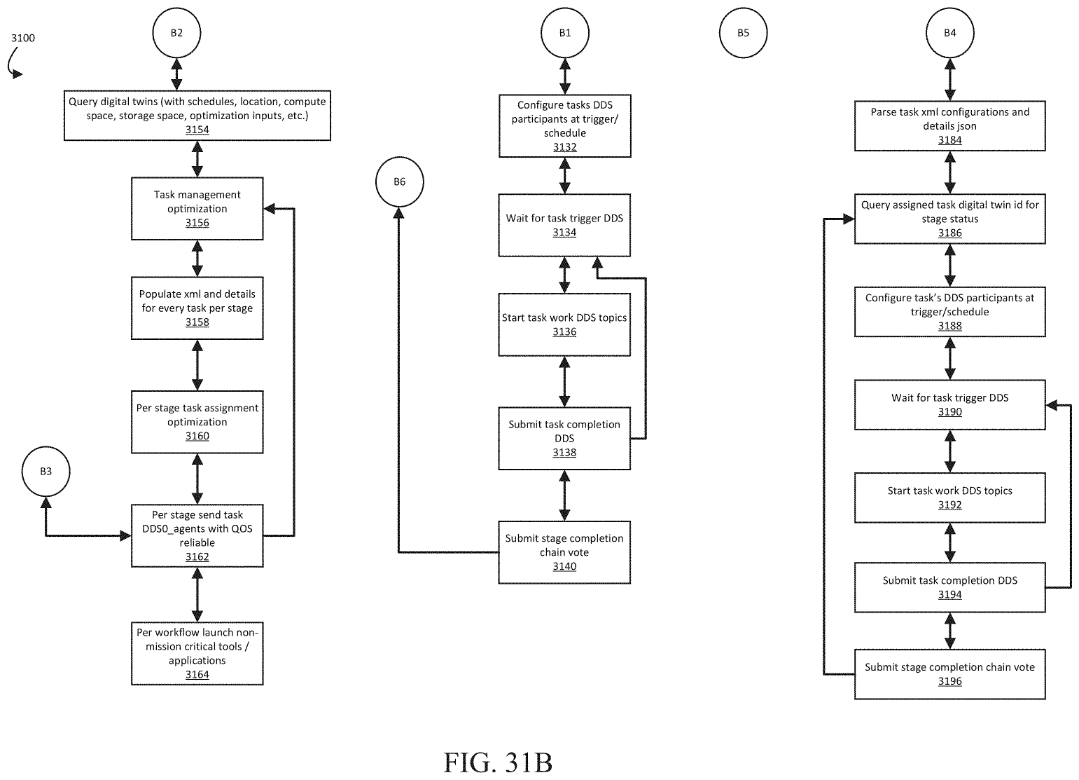

Illustrated in FIGS. 31A and 31B is a non-limiting example of another architecture 3100 for a system for orchestrating a plurality of agents, in accordance with embodiments of the current disclosure. The architecture 3100 may include processes and/or components that provide for an agent process flow 3110 and/or a mobile application agent process flow 3112. In embodiments, agent process flow 3110 may provide for agent, as described herein, to initiate and/or participate in a mission, task, and/or workflow automatically, whereas the mobile application agent process flow 3112 may provide for a human to generate and/or participate in a mission, task, and/or workflow.

For the agent process flow 3110, a user 3114 (which may be an agent) may access an interface to either register itself and/or create an instance of itself within the system at 3116. Registration and/or creation of the user 3114 may include populating twin data 3118, e.g., making a digital twin of the user 3114. At 3120, a digital wallet id may be created in DDS and persistent objects maybe created in ipfs. The digital twin of the user 3114 may then be updated 3122 with a specific status and set to listen at 3124, e.g., the DDS_0 participant may be initialized. The user then waits 3126 to be assigned a task, or subtask, at 3126. Once a task, or subtask, is assigned and matches the digital twin, the associated xmls data for the task, including the details thereof, may be parsed at 3128 and should match the assigned task twin. The user 3114 then waits for a stage trigger at 3130, e.g., a workflow trigger for stage 1). Participants for the corresponding DDS may be configured at the trigger and/or otherwise in accordance with the schedule 3132. The user 3114 then waits for the task trigger DDS at 3134 to start the work DDS topics at 3136. When the user 3114 believes it has completed its assigned task, a task completion message may be submitted 3138 for a chain vote at 3140. As shown in FIG. 31B, after submitting the task completion message, the user 3114 may wait for the task trigger DDS at 3134, and/or a stage trigger 3130 after the vote 3140.

In embodiments, an assignment core may then be launched at 3146 with one or more sentry services, e.g., a scheduler, router, etc., spun up for the workflow at 3148. The sentry may begin to listen for consensus transaction events, e.g., tmint grpc workflow events, at 3150 and/or parse a new workflow at 3152. Digital twins (with schedules, location(s), compute space(s) storage space(s), optimization input(s), etc.) may be queried at 3154 with task management optimization occurring at 3156. At 3158, the xml and details for every task may be populated on a per stage basis with assignment optimization occurring at 3160. At 3162, per stage and task DDS0_agents with quality of service (QOS) may be made reliable, e.g., the message configuration, quality of the service demanding receipt, and/or confirmation of the message. As will be understood, process 3162 may include the sentry node relaying one or more tasks in a secure manner to each agent of the workflow, such communication may occur over one or more secure channels, e.g., DDS, P2P, etc. As shown in FIG. 31B, task management optimization 3156 may be performed again. At 3164, non-mission critical tools and/or applications may be launched per workflow and/or the sentry may continue to listen for consensus transaction events, 3150 e.g., tmint grpc workflow events.

For the mobile application agent process flow 3112, a user 3166, e.g., a human with a smart device running a mobile application forming part of the system as disclosed herein, may access an interface to either register and/or create a user instance within the system at 3168. Registration and/or creation of the user 3166 may include using a json editor to write customizable twin data 3170, e.g., data corresponding to a digital twin, which may be written to the blockchain at 3172. The user 3166 may then, via the application, apply one or more task filters 3174, e.g., the user 3166 may use dropdown, check boxes, etc., to filter out tasks they do not wish and/or are unable to perform. The user 3166 may then begin applying for tasks at 3176. The Application may update the user's twin ready status and task filters 3178 so that the system knows the user is ready to be tasked and what type of tasks to assign them. The application may then initialize a configured DDS domain at 3180, e.g., the DDS_0_ns participant, and then wait to be assigned a task at 3182. At 3184, a received task's xml configurations and/or workflow instructions, e.g., a json file, may be parsed. The assigned task's digital twin id may be queried to determine stage status 3186, with the task's DDS participants being configured at the trigger and/or according to the schedule 3188. The user may then wait for a task trigger DDS 3190, which may subsequently initiate one or more start task work DDS topics 3192. When the user 3166 believes it has completed its task, a task completion DDS may be initiated 3194 for a chain vote at 3196. As shown in FIG. 31B, the after submitting the task completion message, the user 3166 may wait for a task trigger DDS at 3190. As further shown in FIG. 31B, after the chain vote at 3196, the assigned task's digital twin id may be queried to determine stage status 3186. As also shown in FIG. 31A, in embodiments, updating of the twin 3122 and/or 3178 may initiate and/or be considered a twin heartbeat 3197, which may signify the twin is ready for tasking. A twin heartbeat may be a lower level reference of telemetry, which may be used over telemetry when data received and processed is more of a status/connectivity level, as opposed to a function/event. Thus, as will be appreciated, the arrow extending from B5 in FIG. 31B depicts the heartbeat as a continuous process for the duration/existence of a task and/or workflow.

As will be appreciated, the architectures, and/or portions thereof, disclosed herein may be implemented as methods on any of the computing devices disclosed herein.

As will be further appreciated, additional embodiments of the current disclosure may provide for systems and methods for autonomous long range airship fleets.

In embodiments, the plurality of agents may include an aerial vehicle, which may be a dirigible in certain embodiments. The aerial vehicle may include a combination of hardware and software running unique algorithms to process customer data and vehicle navigation/path planning, as described herein.

As will be understood, tensegrity is a technique that may provide structural integrity to a body. Adding tensegrity to a large envelope vehicle, such as an air ship as described herein may provide dynamic aspects to the system as well as benefits beyond static operating conditions. Cable tension, in an example of tensegrity, can be used as an input to the envelope's volume/pressure regulation, which can directly affect a neutral buoyancy point of the vehicle. While an exemplary shape of the vehicle's envelope is that of a ‘bullet’, tensegrity facilitates effecting dynamic geometries of the envelope, and may be utilized to induce different flight characteristics by changing both the moments of inertia of the vehicle and the form factor which interacts with the environment such as lift and drag properties. The vehicle may be configured with an adjustable internal tensegrity structure. A tensegrity structure may be adjusted to facilitate wind surfing by changing the shape of the vehicle to increase or decrease drag along portions of the vehicle relative to other portions, thereby facilitating lift and or directional control. A tensegrity structure may facilitate increasing strength of portions of the vehicle, such as when approaching a docking point, for payload support, and the like.

In embodiments, a lifting gas for use in autonomous vehicles may be hydrogen. The vehicle may include an all-in-one system for collecting water, such as from the environment proximal to the vehicle, to generate hydrogen for storage in a fuel cell, as well as inject hydrogen back into the envelope for sustained neutral buoyancy.

In embodiments portions of the vehicle, such as a passenger, control, or cargo portion may be configured as a breakaway portion. In embodiments a breakaway portion may be configured with carbon fiber materials. In embodiments, yield strength of the unit, and a release pressure of the envelope may be determined so that break away paneling may be configured to rigidly unyielding composites, such as fiberglass can ensure that even under a catastrophic event, the structure is not compromised, just the envelope. Benefits include the insurance that after a catastrophic event related to combustion of the hydrogen, for example, structural elements, motor arms and motors may remain attached with each other and operation so that the vehicle can enter a safe descent mode.

In embodiments, vehicles may have a uniquely large size for the UAV market. With this size, it is possible to carry more sensors in the payload as well as spread the sensors farther apart. Being able to have two or more independent cameras spread at a distance, that may vary through use of tensegrity techniques and the like may facilitate capturing deeper stereo images and thus lead to more detailed 3D reconstructions. In embodiments, a unique stereo reconstruction algorithm that is tied to multiple independent cameras may be designed to quickly and efficiently build a 3D model with greater depth resolution with limited computing resources. The large size may also facilitate mounting sensors, such as cameras and the like, at a variety of distributed positions. In embodiments, processing of images from cameras, including stereo reconstruction that may be useful for vehicle command and control decisions may be performed with processors disposed on the vehicle, thereby increasing near real-time utility of the images.

In embodiments, multiple sensor modes may be combined thereby producing greater than three-dimensional data sets, such as for example, thermal data as a fourth dimension overlaid on a reconstructed three-dimensional image captured from a plurality of cameras disposed on the vehicle. In embodiments, having a large array of sensors and cameras may enable novel avenues of data fusion. In embodiments, each sensor may be operating in coordination with each camera onboard, which may facilitate aligning the sensor data with the camera data taking into account, for example, displacements, distortions, and timing discrepancies. Alignment of multiple sensors may facilitate accuracy of overlaying different datasets, and fusing multiple outputs.

In embodiments, data from a range of sensors include cameras and LIDAR, may be efficiently localized with each other through high resolution positioning information based on knowledge of the position of sensors and adjustments to the envelope made through implementation of tensegrity changes. In an example, applying spatially aligned thermal sensor data (e.g., using an IR sensor and the like) to camera-based image geometry may facilitate detecting hot spots on a transmission line. Automatic detection algorithms may be applied to facilitate annotating images for easy human identification of hot spots and the like.

In embodiments internal and external communication, such as communication among vehicles may be encrypted. Additionally, combining encryption with distribution of ledgers may further enrich data security. In an example, using block chain techniques with encrypted messages may provide a difficult to hack solution for managing and controlling the communications over an autonomous vehicle network. Distribution may also facilitate security by requiring that a vehicle verify the message by checking multiple sources. A hacker would have to hack all available sources to compromise communication integrity. Likewise, an acknowledgement message may require compliance with a distributed ledger sequence. While a message within a ledger may also be encrypted, a block chain distributed ledger may allow for secure validation of the message. The encryption of the messages between and among network participants may be based on standard 512 bit Encryption. Block chain may be utilized to send vehicle command and control signals to a vehicle securely.

To ensure that the end-to-end communications and control systems are not allowed to be usurped, the security design of the autonomous fleet infrastructure is considered an integral part of every component of the system including every message.

Each subsystem of agents may have a unique identifier and a way to create a unique string in a sequence that can only be understood by other participants in the network. In embodiments, this unique string may be placed in the header of each message and may be different with each message. This may allow the network to verify the origin and validity of the message.

Communicating mission information to an agent may include a Mission Communications Structure (MCS) that may be secure, accepted, human and machine readable, and extensible. An exemplary MCS may use XML as a core template that can be built, securely sent, acknowledged by the agent, accepted (or rejected) by the agent, and recommunicated securely by the agent to delegate part or all of the mission to other agents, while still tracking the mission centrally.

In embodiments an MCS schema of XML may reserve tags by the language, while providing a fluid mechanism for communicating and interpreting the core of the mission using both structured and unstructured methods. A non-limiting example of a MSC is provided below in table 1.

TABLE 1
Mission Communications Structure (MCS)

<mission_wrapper id=””>
<mission_title basetemplate=”” basetemplateversion=””
customname=””></mission_title>
<mission_objective_description></mission_objective_description>
<route_base_type>linear, area</route_base_type>
<linear_way_point_array>
<sensor_package>
<sensor_name=”” status=”enabled,disabled” record=”y,n”>
<sensor_parameter>
<name></name>
<value></value>
</sensor_parameter>
</sensor>
<point x=”” y=”” z=”” ztype=”agl, asl” zformat=”m” heading=”0-360”
speed=”” speedformat=”mph,kph”/>
</sensor_package>
</linear_way_point_array>
</mission_wrapper>

Much like the MCS, an Agent Registry Structure (ARS) may provide a flexible approach to defining the specifications and capability of a wide variety of agents into an agent registry. These registry entries are utilized by Intersect to select agents to be tasked on missions appropriate to their capabilities. A non-limiting example of an ARS is provided below in table 2.

TABLE 2
Agent Registry Structure (ARS)

<agent_wrapper>
<agent_id id_format=””></agent_id>
<physical_attributes>
<robot_form></robot_form>
<robot_motility_mechanism></ robot_motility_mechanism>
<robot_max_speed format=”kph”>/
<robot_nominal_endurance format=”hrs”>/
<robot_physical_dimensions>
<z_axis format=”cm”>/
<x_axis format=”cm”>/
<y_axis format=”cm”>/
<weight condition=”nominal” format=”kg”>/
<weight condition=”maximum” format=”kg”>/
</robot_physical_dimensions>
<sensor_package>...</sensor_package>
<material_handling>...</material_handling>
<hasmat_capabilities>.../
<energy_system>/
<computing_systems>
<operating_system>.../
<communications_protocols>.../
<onboard_storage>.../
</computing_systems>
<autonomy_systems>
</agent_wrapper>

In embodiments, autonomous vehicles or agents such as self-driving cars, drones, voice assistants, robots, and others may facilitate a major shift away from human labor to autonomous systems. In the US alone, there are over 3 million truck drivers who may shortly be replaced by self-driving systems. These systems are attractive to logistics operators due to the safety, endurance, and cost advantages over human drivers. However, truck drivers for instance do more than merely “take the wheel” when it comes to the overall logistics workflow. Long term there need to be systems that know when a truck arrives at a refueling or recharging station, when it arrives at a terminal for unloading and what to unload. Once unloaded from the truck, it typically must be determined where the various types of cargo need to be stored in the warehouse and what truck they go to next.

Methods and systems of autonomous vehicle infrastructure may integrate and orchestrate various autonomous systems, regardless of manufacturer, together to create a unified workflow. This workflow can even include humans into the control and functional loops. In embodiments, networks such as IP based networks (IoT), protocols for communication (XML), abstracted scheduling, system registry, and hardware and the like may be employed in the infrastructure. In today's industrialized and interconnected world, it takes teams of people and technology working in harmony to keep things moving forward. The autonomous vehicle infrastructure may include parallel and serial workflows with meaningful intersections or touch-points along the way. In embodiments, cooperative systems may include elements that facilitate succeeding in the goals and objectives of the task or tasks, such as automating today's manual or semi-automated processes. Elements that facilitate succeeding may, without limitation include the following: communication, capabilities, planning, motivation, achievable, and objectives.

Regarding communications, a globally understandable language that unambiguously communicates concepts and can easily be acknowledged is advantageous within cooperative systems, as described herein. For example, humans often communicate using common spoken and written languages. Accordingly, the MCS may use code to communicate with systems. Intelligent agents may need to know what to do and when. Such agents may need to be able to accept a mission and deal with change and/or be able to communicate issues and failures. Such agents may also need to be able to pass on information to the next agent in line. A defined language with controlled vocabulary, structured, and unstructured data may provide for agents to communicate with each other. This language may be both human and machine readable.

Regarding capabilities, it is often beneficial to select the right tool for the right job. When looking at a particular task and/or job, one typically considers who and/or what could best accomplish the task. It is often the case that a human will intuitively know who would be best for a job but still develop job descriptions. Accordingly, embodiments of the current disclosure may develop RFPs for a specific task to see who will best match the requirements. A unified protocol for sharing the capabilities of an agent's embodiment may be available to the planners and coordinators of the mission. Some embodiments of the current disclosure may require such an RFP for both human and autonomous planning systems. In embodiments, the manifest could be structured to be extensible and easy to use and disseminate. Relevant protocols may capture, among other things, the physical characteristics of the system such as size, weight, and motility.

Regarding planning, this term, as used herein, refers to the process of developing the resources, tasks, and timing to achieve a project's objectives. Even though resources in a particular scenario may be autonomous systems that can think and react on their own, it is often important to have one unified plan that can be monitored as the mission progresses. Further, the plan can be used to adjust in the case of failures or other events that affect the timeline or completion of the mission. Without a centralized system it may be difficult to schedule and monitor autonomous systems working together. As will be appreciated, embodiments of the current disclosure may serve as an information gathering and dissemination repository during planning and operation of a mission. In embodiments, plans can be used to nest or connect to create more complex missions. For the planning component of Intersect to work the generation of the plan may also be highly automated to create “fool proof” plans that take into account a wide range of variables, mission types, geographies and physical locations, regulations and other constraints, agent and robot specifications, and real-time reporting.

Regarding motivation, all creatures may need motivation to exert energy to do something for someone else. Although robots are not creatures and they can be forced to do tasks whether they want to or not, it may be important that they have an enthusiasm to work. As will be appreciated, this may be important because the economics of autonomous systems may significantly change in the future. Additionally, there may be system-wide constraints. Agents may have the choice for which tasks they choose to do. There may be times when they can travel a longer distance to do a task or stay local and do a similar task. They may need to be motivated to choose one over the other. Regarding achievable objectives, as with human workers, autonomous systems may need clear objectives. They may need to know as much as possible about the task(s), success criteria, and what defines failure. To ensure completeness, quality, and expected results, the mission and tasks may need thoroughly detailed information. This may be challenging since robots work differently from people. For example, suppose a robot is told/instructed that a truck will need to be unloaded when the truck arrives. If the truck arrives at 8:00 am, then a robot may arrive to wait for the truck at 6:00 am. Such a situation could be problematic if three trucks arrive between 6:00 am and 8:00 am that the robot was not tasked to unload. The robot could be in the way or may try to unload the wrong truck. It may be important to be explicit about what to do and what not to do.

To address the factor of agent motivation a cryptocurrency may be provided to be exchanged for tasks, i.e., embodiments of the current disclosure contemplate use of Robot Payment Coins (RPC) among autonomous systems and/or humans. The RPC may be a non-monetary object for an agent program to collect as a reward mechanism for engaging in tasks. A function for configuring agents to address a mission could offer an increased amount of coins to an agent program, such as more coins than a minimum threshold for the agent to choose the mission, to tip the scales in favor of the agent choosing it over another mission.

Without limitation to any other aspect of the present disclosure, aspects of the disclosure herein may provide for improved efficiencies of an automated port. For example, some embodiments of the platform may provide for coordination of agents, as described herein, at a level superior to what a human and/or group of humans could achieve. As will be appreciated, this may be due in part to the ability of the platform to collect and process amounts of information over periods of time that a human and/or group of humans are not practically capable of. For example, coordination of multiple agents in a complex industrial environment generally requires real-time and/or near real-time collection and/or processing of amounts of data that would take a human and/or group of humans hours and/or days to complete. Additionally, some embodiments of the current disclosure may provide for seamless integration of disparate agents and/or other systems within an industrial environment such as a port facility.

Accordingly, some embodiments of the current disclosure provide for a system for orchestrating a plurality of agents. The system includes an electronic device and a server. The electronic device is structured to display a graphical user interface that generates maneuver configuration data for configuring a shared maneuver for the plurality of agents. The electronic device is further structured to transmit the maneuver configuration data. The server is in electronic communication with the electronic device and has a maneuver interface circuit, a maneuver configuration circuit, an agent data collection circuit, an agent coordination circuit, and an agent command value provisioning circuit. The maneuver interface circuit is structured to interpret the maneuver configuration data. The maneuver configuration circuit is structured to configure the shared maneuver based at least in part on the maneuver configuration data. The agent data collection circuit is structured to interpret first agent data and second agent data, the first agent data corresponding to a first agent of the plurality of agents and the second agent data corresponding to a second agent of the plurality of agents. The agent coordination circuit is structured to generate a plurality of coordinated agent command values configured to operate the first and the second agents based at least in part on the configured shared maneuver, the first agent data, and the second agent data. The agent command value provisioning circuit is structured to transmit the plurality of coordinated agent command values. In certain embodiments, the agent coordination circuit is further structured to generate a plurality of microservices, wherein the plurality of coordinated agent command values is generated by the plurality of microservices and coordinated agent command values of the plurality generated by different microservices are of different types. In certain embodiments, at least one of the plurality of microservices corresponds to at least one of: traffic deconfliction for the plurality of agents; traffic prioritization for the plurality of agents; or execution of at least one of a mission or a task by one or more of the plurality of agents. In certain embodiments, the server further includes a replicate circuit structured to generate a digital twin corresponding to the first agent. In such embodiments, the agent coordination circuit is further structured to generate the plurality of coordinated agent command values based at least in part on the digital twin. In certain embodiments, the server further has a simulation circuit structured to simulate the shared maneuver based at least in part on the digital twin. In such embodiments, the agent coordination circuit is further structured to generate the plurality of coordinated agent command values based at least in part on the simulation of the shared maneuver. In certain embodiments, the system further includes the plurality of agents. In certain embodiments, the first agent is of a different type than the second agent. In certain embodiments, the first agent and the second agent respectively electronically communicate the first agent data and the second agent data via different protocols. In certain embodiments, the plurality of agents includes at least one of: a vehicle, a microservice; or a mobile electronic device. In certain embodiments, the first agent is an unmanned vehicle. In certain embodiments, the second agent is a manned vehicle.

Some embodiments of the current disclosure may provide for an apparatus for orchestrating a plurality of agents. The apparatus may include a maneuver interface circuit, a maneuver configuration circuit, an agent data collection circuit, an agent coordination circuit, and an agent command value provisioning circuit. The maneuver interface circuit may be structured to interpret maneuver configuration data. The maneuver configuration circuit may be structured to configure a shared maneuver for the plurality of agents based at least in part on the maneuver configuration data. The agent data collection circuit may be structured to interpret first agent data and second agent data, the first agent data corresponding to a first agent of the plurality of agents and the second agent data corresponding to a second agent of the plurality of agents. The agent coordination circuit may be structured to generate a plurality of coordinated agent command values configured to operate the first and the second agents based at least in part on the configured shared maneuver, the first agent data, and the second agent data. The agent command value provisioning circuit may be structured to transmit the plurality of coordinated agent command values. In certain embodiments, the agent coordination circuit is further structured to generate a plurality of microservices, wherein the plurality of coordinated agent command values is generated by the plurality of microservices and coordinated agent command values of the plurality generated by different microservices are of different types. In certain embodiment, at least one of the plurality of microservices corresponds to at least one of: traffic deconfliction for the plurality of agents; traffic prioritization for the plurality of agents; or execution of at least one of a mission or a task by one or more of the plurality of agents. In certain embodiments, the apparatus further includes a replicate circuit structured to generate a digital twin corresponding to the first agent. In such embodiments, the agent coordination circuit is further structured to generate the plurality of coordinated agent command values based at least in part on the digital twin. In certain embodiments, the apparatus further includes a simulation circuit structured to simulate the shared maneuver based at least in part on the digital twin. In such embodiments, the agent coordination circuit is further structured to generate the plurality of coordinated agent command values based at least in part on the simulation of the shared maneuver.

Yet other embodiments of the current disclosure provide for a method for orchestrating a plurality of agents. The method includes interpreting maneuver configuration data; configuring a shared maneuver for the plurality of agents based at least in part on the maneuver configuration data; interpreting first agent data corresponding to a first agent of the plurality of agents; and interpreting second agent data corresponding to a second agent of the plurality of agents. The method may further includes: generating a plurality of coordinated agent command values configured to operate the first and the second agents based at least in part on the configured shared maneuver, the first agent data, and the second agent data; and transmitting the plurality of coordinated agent command values. In certain embodiments, the method may further include displaying, on an electronic device, a graphical user interface; generating, via the graphical user interface, the maneuver configuration data; and transmitting, via the electronic device, the maneuver configuration data. In certain embodiments, the method further includes generating a digital twin corresponding to the first agent; and adding the digital twin to a blockchain. In such embodiments, generating a plurality of coordinated agent command values is based at least in part on the digital twin and the blockchain. In certain embodiments, the method further includes simulating the shared maneuver based at least in part on the digital twin. In such embodiments, generating a plurality of coordinated agent command values is further based at least in part on the simulation of the shared maneuver. In certain embodiments, the method further includes transmitting data for displaying, on an electronic device, a graphical user interface structured to generate the maneuver configuration data, and receiving, from the electronic device, the maneuver configuration data. In certain embodiments, the method may further include generating a digital twin corresponding to the first agent, and transmitting the digital twin to a blockchain. In such embodiments, generating a plurality of coordinated agent command values is based at least in part on the digital twin and the blockchain.

Still yet other embodiments provide for a method that includes capturing images from an autonomous air vehicle, and, based on detection of an event indicative of a need for additional information, adjusting a path of the vehicle to facilitate capture of images from a plurality of perspectives of the detected event. A processor on the autonomous air vehicle performs the detecting, adjusting, and capture of images from the plurality of perspectives.

Still yet other embodiments may provide for a routing device for a manned vehicle in a private or a closed location, e.g., a campus. The routing device may be configured to identify a manned vehicle. Identifying may be accomplished via scanning a manned vehicle identification number in a bar-code attached on or associated with the manned vehicle. Identifying may include obtaining GPS position data of the manned vehicle and/or the geographic data surrounding the manned vehicle. In certain aspects, the manned vehicle is a car, truck, or drone. The routing device may be configured to send the identification to the cloud server. The routing device may be configured to receive a specific mission associated with the identified manned vehicle from a cloud server. In certain aspects, the specific mission may include: a mission to deliver an asset, cargo or luggage from a first position to a second position in the private or closed location; recommended routing data from the first to the second position, wherein, in certain aspects, the moving of the manned vehicle can be traced/updated live/real-time; map data of the location, which may be stored in an application installed and/or executing at the routing device; and/or moving statuses of other manned vehicle(s) and/or unmanned/autonomous vehicle(s) in the location. In embodiments, the recommended routing data may be determined at the cloud server so that a specific project may be effectively orchestrated in a manned and an unmanned/autonomous vehicles mixed situation by a routing algorithm (potentially using AI/ML). In certain aspects, non-limiting examples of data that may be referenced by the routing algorithm (with AI/ML system) include: live hazard or vehicle congestion in the location; statistic congestion data, e.g., by time; typical route(s) between position A and B; feedback data regarding the previous specific project; a customer's ERP (Enterprise Resource Plaining) or management data; and/or any other specific/unique feature(s) of the processing or the API about the routing algorithm. The routing device may be further configured to display the specific mission and the recommended routing data for the identified manned vehicle on a screen of the routing device. In certain aspects, the routing device may display this data along with moving statuses of other manned vehicle(s) and/or the unmanned vehicle(s) on the map of the private or the closed location. In certain aspects, the recommended routing data may be audio data provided from a speaker of the routing device (along with an image of the recommended route on the screen, or as an alternative to displayed data on the screen.). Accordingly, embodiments of the current disclosure may provide for a method of routing a manned vehicle that includes: identifying a manned vehicle in a private or closed location; sending the identification number to a cloud server' receiving from the cloud server data for a specific mission associated with the identified manned vehicle; and displaying the data for a specific mission and/or the recommended routing data for the identified manned vehicle on a screen of a routing device associated with the manned vehicle. In certain aspects, identifying the manned vehicle may be performed via scanning a manned vehicle identification number in a bar-code attached to or associated with the manned vehicle. In certain aspects, identifying the manned vehicle may further include obtaining GPS position data of the manned vehicle and/or geographic data surrounding the manned vehicle. In certain aspects, the manned vehicle is a car, truck, or drone. In certain aspects, the specific mission may include: a mission to deliver an asset, cargo or luggage from a first position to a second position in the private or closed location; recommended routing data from the first to the second position, wherein, in certain aspects, the moving of the manned vehicle can be traced/updated live/real-time; map data of the location, which may be stored in an application installed and/or executing at the routing device; and/or moving statuses of other manned vehicle(s) and/or unmanned/autonomous vehicle(s) in the location. In certain aspects, the displaying may include providing a moving status of other manned vehicle(s) and/or the unmanned vehicle(s) on map data of the private or the closed location. In embodiments, the displaying may include providing audio data for the specific mission and/or the recommended routing data via a speaker of the routing device associated with the manned vehicle.

Still yet other embodiments may provide for a method that includes: providing, to a client device, data for displaying a GUI on a display device; receiving, based on user input to the GUI, user input for a workflow; forming, using a platform, the workflow based on the user input; generating one or more of routing data and scheduling data for the workflow; and providing the one or more of routing data and scheduling data for the workflow to one or more devices. In certain aspects, the workflow may include one or more mission parts to be performed by one or more manned or unmanned vehicles in a location. In certain aspects, the workflow may include and/or be based at least in part on one or more vehicle type and associated tasks. In certain aspects, the one or more devices include the client device and/or the one or more manned or unmanned vehicles. In certain aspects, the one or more devices include one or more manned or unmanned vehicles of different types. In such embodiments, the vehicles may utilize different communications protocols. The method may further include tracking, by the platform, the one or more manned or unmanned vehicles during performance of the one or more mission parts. In certain aspects, the tracking may include providing an indication to an external system related to the one or more mission parts. In certain aspects, the tracking may include providing and/or transmitting one or more of a vehicle location, an asset location, and a mission or mission part status.

Still yet other embodiments may provide for a method that includes: receiving, at a platform, a communication associated with a vehicle; determining, by the platform, the communication corresponds to a mission plan having one or more parts impacting a route; and identifying, by the platform, one or more conflicting scheduled routes for one or more other vehicles associated with the route. The method may further include: prioritizing, by the platform, the vehicle and the one or more other vehicles associated with the route; and communicating, to the vehicle, a mission plan adjusted to accommodate the one or more other vehicles. In certain aspects, the vehicle and the one or more other vehicles may be unmanned vehicles. In certain aspects, prioritizing includes choosing a vehicle from among the vehicle and the one or more other vehicles based on one or more of a time of day, a vehicle type, a vehicle condition, a mission type, and a vehicle payload.

Still yet other embodiments may provide for a method that includes receiving, at a platform, data from an unmanned vehicle; identifying, by the platform, one or more other unmanned vehicles; providing, by the platform, a message formatted for the one or more other unmanned vehicles to a memory location based on the data from the unmanned vehicle; and, thereafter, making, by the platform, the message accessible to the one or more other unmanned vehicles. The method may further include: registering a set of unmanned vehicles of different types; indicating, to a user device, compatible vehicles from the set; and in response to an indication from the user of a mission having one or more parts to be performed by one or more of the vehicles from the set.

Still yet other embodiments may provide for a method that includes: receiving, from a platform, data of a mission plan for an unmanned vehicle; identifying, by the unmanned vehicle, one or more trusted sources; and querying, by the unmanned vehicle, the one or more trusted vehicles in association with the data of the mission plan. The method may further include: receiving, by the unmanned vehicle, an indication in response to the querying; and determining, by the unmanned vehicle, that the data of the mission plan is valid. In certain aspect, the method may further include, thereafter, moving, by the unmanned vehicle, according to the data of the mission plan.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

As will be understood, embodiments of the present disclosure may provide for benefits which will be apparent to those skilled in the art upon reading the present disclosure. For example, some embodiments of the present disclosure provide for decentralized and/or protected digital twins which may further provide for secure intra-fleet collaboration among various agents and/or other assets, as described herein. Some embodiments of the present disclosure may provide for a platform that orchestrates human and machine, e.g., robots, drones, autonomous cars, systems of systems, etc. As will be further understood, such orchestration of human and machine may further provide for improved safety in automated environments, e.g., ports, warehouses, factories, etc., having complex workflows, as well as the trustless systems, which may enable open interaction in any space. Some embodiments of the present disclosure may include a peer-to-peer (p2p) layer that provides for deterministic chain states and/or encryption of tasks and/or service configurations. Embodiments of the present disclosure may also provide for decentralized applications and/or tools for that allow users to design, build, and/or test consensus driven tasks and/or workflow instructions. The microservices, of some embodiments described herein, may provide for efficient and/or open interactions and/or trustless tasks in secured real-time environments. Further, the one or more blockchains of some embodiments, as described herein, may provide for real-time domains for interactions among humans and/or autonomous systems. Embodiments of the present disclosure may provide: for real-time robotic collaboration with autonomous coordination and job completion amongst robots, disparate systems, and/or people; shared robot perception with secure layered communication(s) to facilitate work in task-specific isolated environments; and/or for the deployment of real-time microservices for local workflow planning and/or orchestration. Certain embodiments of the present disclosure may provide for optimization and automation of existing facilities, e.g., industrial ports, warehouses, etc., which in turn, may increase asset utilization and/or provide for efficient low down times and/or high utilization intelligent planning and scheduling in audited safe environments. Some embodiments may provide for complex interactions with digital twins secured behind blockchain technologies and/or configuration of multi-system interactions with digital twin and task ledgers, which may further provide for the protection of assets from malicious attacks, faulty commands, and/or outlier decision making Embodiments may provide for the exchange and engagement of verified tasks on a distributed consensus network. Some embodiments may provide for secure sovereignty over data in distributed storage, which may be hosted by other systems; and/or for the encryption of permissions data for individual tasks and/or agents configured by blockchain logic. Certain embodiments may provide for federated storage distributed amongst agents which may improve fault tolerance, content delivery networks (CDN), and/or immutable data over known automation technologies. Embodiments of the present disclosure may also provide for seamless spanning of blockchain-to-real-time data spaces with digital twins. Certain embodiments of the present disclosure may utilize application specific blockchains to facilitate open interactions with other chains, which in turn, may provide for collaboration safely across businesses, nations, and/or other types of boundaries. The digital twins of some embodiments may be linked securely through blockchains to unlock simulations, provide for interacting multiverse virtual and/or augmented reality assets, and/or provide for optimization engines for high performance tasking. Some embodiments may provide for the monetization and recycling of tasks and/or services, and/or continuously scale automation capabilities without up-front investment infrastructure and/or skill. Some embodiments of the present disclosure may enable vehicle owners to monetize their vehicles and/or otherwise provide for new revenue stream generation through missions and/or data collection. Embodiments of the present disclosure may provide for developers to build real-time microservices and/or smart contract interactions. By providing for an easy-to-use interface/mobile application, embodiments of present disclosure may help less tech-savvy individuals to engage with trusted agents and/or task ecosystems. Some embodiments of the present disclosure may provide for transactions of digital assets and/or tasks globally between businesses and/or individuals via blockchain linked assets and/or agents. Embodiments of the present disclosure may provide for the linking of internal and external operating environments to the internet of blockchains and/or provide for the scaling and/or upgrading of blockchain states easily, e.g., without large downtimes and/or reconfigurations.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed is:

1. A system for orchestrating a plurality of agents, the system comprising:
an electronic device structured to display a graphical user interface that generates maneuver configuration data for configuring a shared maneuver for the plurality of agents, the electronic device further structured to transmit the maneuver configuration data; and
a server in electronic communication with the electronic device and having:
a maneuver interface circuit structured to interpret the maneuver configuration data;
a maneuver configuration circuit structured to configure the shared maneuver based at least in part on the maneuver configuration data;
an agent data collection circuit structured to interpret first agent data and second agent data, the first agent data corresponding to a first agent of the plurality of agents and the second agent data corresponding to a second agent of the plurality of agents;
an agent coordination circuit structured to generate a plurality of coordinated agent command values configured to operate the first and the second agents based at least in part on the configured shared maneuver, the first agent data, and the second agent data; and
an agent command value provisioning circuit structured to transmit the plurality of coordinated agent command values.

2. The system of claim 1, wherein the agent coordination circuit is further structured to generate a plurality of microservices, wherein the plurality of coordinated agent command values is generated by the plurality of microservices and coordinated agent command values of the plurality generated by different microservices are of different types.

3. The system of claim 2, wherein at least one of the plurality of microservices corresponds to at least one of:
traffic deconfliction for the plurality of agents;
traffic prioritization for the plurality of agents; or
execution of at least one of a mission or a task by one or more of the plurality of agents.

4. The system of claim 1, wherein the server further comprises:
a replicate circuit structured to generate a digital twin corresponding to the first agent; and
the agent coordination circuit is further structured to generate the plurality of coordinated agent command values based at least in part on the digital twin.

5. The system of claim 4, wherein the server further comprises:
a simulation circuit structured to simulate the shared maneuver based at least in part on the digital twin; and
the agent coordination circuit is further structured to generate the plurality of coordinated agent command values based at least in part on the simulation of the shared maneuver.

6. The system of claim 1 further comprising:
the plurality of agents.

7. The system of claim 6, wherein the first agent is of a different type than the second agent.

8. The system of claim 6, wherein the first agent and the second agent respectively electronically communicate the first agent data and the second agent data via different protocols.

9. The system of claim 1, wherein the plurality of agents includes at least one of:
a vehicle, a microservice; or a mobile electronic device.

10. The system of claim 9, wherein the first agent is an unmanned vehicle.

11. The system of claim 10, wherein the second agent is a manned vehicle.

12. An apparatus for orchestrating a plurality of agents, the apparatus comprising:
a maneuver interface circuit structured to interpret maneuver configuration data;
a maneuver configuration circuit structured to configure a shared maneuver for the plurality of agents based at least in part on the maneuver configuration data;
an agent data collection circuit structured to interpret first agent data and second agent data, the first agent data corresponding to a first agent of the plurality of agents and the second agent data corresponding to a second agent of the plurality of agents;
an agent coordination circuit structured to generate a plurality of coordinated agent command values configured to operate the first and the second agents based at least in part on the configured shared maneuver, the first agent data, and the second agent data; and
an agent command value provisioning circuit structured to transmit the plurality of coordinated agent command values.

13. The apparatus of claim 12, wherein the agent coordination circuit is further structured to generate a plurality of microservices, wherein the plurality of coordinated agent command values is generated by the plurality of microservices and coordinated agent command values of the plurality generated by different microservices are of different types.

14. The apparatus of claim 13, wherein at least one of the plurality of microservices corresponds to at least one of:
traffic deconfliction for the plurality of agents;
traffic prioritization for the plurality of agents; or
execution of at least one of a mission or a task by one or more of the plurality of agents.

15. The apparatus of claim 12 further comprising:
a replicate circuit structured to generate a digital twin corresponding to the first agent;
wherein the agent coordination circuit is further structured to generate the plurality of coordinated agent command values based at least in part on the digital twin.

16. The apparatus of claim 15 further comprising:
a simulation circuit structured to simulate the shared maneuver based at least in part on the digital twin;
wherein the agent coordination circuit is further structured to generate the plurality of coordinated agent command values based at least in part on the simulation of the shared maneuver.

17. A method for orchestrating a plurality of agents, the method comprising:
interpreting maneuver configuration data;
configuring a shared maneuver for the plurality of agents based at least in part on the maneuver configuration data;
interpreting first agent data corresponding to a first agent of the plurality of agents;
interpreting second agent data corresponding to a second agent of the plurality of agents;
generating a plurality of coordinated agent command values configured to operate the first and the second agents based at least in part on the configured shared maneuver, the first agent data, and the second agent data; and
transmitting the plurality of coordinated agent command values.

18. The method of claim 17 further comprising:
transmitting data for displaying, on an electronic device, a graphical user interface structured to generate the maneuver configuration data; and
receiving, from the electronic device, the maneuver configuration data.

19. The method of claim 17 further comprising:
generating a digital twin corresponding to the first agent; and
transmitting the digital twin to a blockchain;
wherein generating a plurality of coordinated agent command values is based at least in part on the digital twin and the blockchain.

20. The method of claim 19 further comprising:
simulating the shared maneuver based at least in part on the digital twin;
wherein generating a plurality of coordinated agent command values is further based at least in part on the simulation of the shared maneuver.
